(19) United States
(12) Patent Application Publication
(10) Pub. No.: US 2007/0180159 A1
(43) Pub. Date: Aug. 2, 2007

(54) IMAGE FORMING APPARATUS AND JOB CONTROL METHOD

(75) Inventor: Hiroyuki TAKAHASHI, Ohta-ku, Tokyo (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Ohta-ku (JP)

(21) Appl. No.: 11/627,462

(22) Filed: Jan. 26, 2007

(30) Foreign Application Priority Data
Jan. 31, 2006 (JP) 2006-023623

(51) Int. Cl. G06F 3/00

(52) U.S. Cl. 710/8

(57) ABSTRACT

A job processing method in an image forming apparatus having a normal mode and a service mode, which enables reception of a normal job even in the service mode (for example, during maintenance work), and enables efficient processing of the received job. In the job processing method, a user interface is provided for previously selecting processing for a job input during the service mode by a user. The job inputted in the service mode is processed in accordance with the processing selected by using the user interface.

### BACKGROUND OF THE INVENTION

1. Field of the Invention

The present invention relates to a job management technique in an image forming apparatus.

2. Description of the Related Art

Generally, in an environment of an image forming apparatus, an experienced expert with knowledge of image forming apparatus, called a service person, performs installation of an image forming apparatus or periodically performs maintenance work.

However, in recent years, in a POD (Print On Demand) environment, a so-called operator maintenance, i.e., a maintenance support operation performed by an operator including replenishment of consumables and changing of periodical exchange parts, is widely performed. On the other hand, to efficiently perform installation and maintenance work, a software program to remotely perform a device maintenance operation on a PC has been introduced.

Further, generally, the maintenance work by a service person is performed in a local environment where an image forming apparatus is disconnected from a network. That is, the maintenance work is performed in a status where the image forming apparatus as the subject of maintenance work is exclusively handled by the service person. Generally, as a service person is a person outside of the office or site where the image forming apparatus is placed, it is desirable that the maintenance work is performed in an islet environment (disconnected from the network) from the viewpoint of concentration of support operation, prevention of job input within the office or site, and security problem.

Japanese Patent Application Laid-Open No. 10-294844 discloses a system to, when a remote maintenance request can be accepted, prohibit reception of other jobs, then receive the remote maintenance request, and analyze the contents of the maintenance request. In this system, the remote maintenance or job processing is selected and the maintenance is performed substantially in a local environment.

On the other hand, when an operator performs maintenance work, the operator often is in charge of the office or site. In this case, the operator grasps the situations in the office or site. Accordingly, input of jobs can be permitted to a certain degree. Further, as the security is attained, management with preference to the efficiency of entire office/site operation is desired. Accordingly, in such case, it is desirable that the image forming apparatus is not disconnected from the network, and a job inputted during the maintenance work is held in the image processing apparatus.

That is, generally, it is preferable that upon maintenance, the service person applies his/her mind to maintenance work, however, the requirement of simultaneous execution of maintenance work and normal print jobs should be taken into consideration. However, if the maintenance work and normal print jobs are performed in parallel, the management of print jobs regarding processing timings, processing order and the like become complicated.

### SUMMARY OF THE INVENTION

The present invention has been made in consideration of the above problems, and has an object to enable reception of normal jobs during a service mode (e.g., during maintenance work) and to enable efficient processing of the received jobs.

According to one aspect of the present invention, there is provided a job processing method in a job processing apparatus operative in a normal mode to execute normal job processing and in a service mode, comprising: a job processing selection step of previously selecting job processing for a job inputted in the service mode; and a job processing execution step of processing a job inputted in the service mode in accordance with the processing selected at the job processing selection step.

Also, according to another aspect of the present invention, there is provided a job processing method in a job processing apparatus connectable to an external device via a network, comprising: a control step of executing an operation mode selected from plural operation modes including a normal mode to process a job inputted from the external device or the job processing apparatus and a service mode to perform previously set service in accordance with an instruction from the external device or the job processing apparatus; a job processing selection step of previously selecting job processing for a job inputted in the service mode; and a job processing execution step of applying processing according to the job processing selected at the job processing selection step to a job inputted from the external device or the job processing apparatus in the service mode.

Further features of the present invention will become apparent from the following description of exemplary embodiments with reference to the attached drawings.

### BRIEF DESCRIPTION OF THE DRAWINGS

FIG. 1 is a block diagram showing an example of the system configuration of an image forming apparatus according to an embodiment of the present invention;

FIG. 2 is a block diagram showing a detailed configuration of an MFP (Multi Function Peripheral) according to the embodiment;

FIG. 3A illustrates an example of the structure of an operation unit of the MFP;

FIG. 3B illustrates an example of the structure of a key input unit of the operation unit of the MFP;

FIG. 3C illustrates an example of the structure of a touch panel of the operation unit of the MFP;

FIG. 4A is a cross-sectional view showing the structure of a printer unit of the MFP;

FIG. 4B is a cross-sectional view showing the structure of a scanner unit of the MFP;

FIG. 4C is a cross-sectional view showing the structure of an image generation unit of the printer unit;

FIG. 4D is a cross-sectional view showing the structure of a paper conveyance system of the printer unit;

FIG. 4E is a cross-sectional view showing the structure of a fixing unit of the printer unit;

FIG. 4F illustrates a paper conveyance system of the fixing unit;

FIG. 5A illustrates the structure of an ADF unit;

FIG. 5B is a cross-sectional view showing the structure of the ADF unit;

FIG. 6 is a cross-sectional view showing the structure of an in-line finisher unit;

FIG. 7A illustrates an example of a printer driver screen on a client computer;

FIG. 7B illustrates an example of a printer driver property setup screen on the client computer;

FIG. 7C illustrates an example of the printer driver property setup screen on the client computer;

FIGS. 8A and 8B are timing charts showing a normal print operation and an operation during service maintenance work;

FIGS. 9A to 9C are timing charts showing the normal print operation and the operation during the service maintenance work according to the embodiment;

FIGS. 10 to 12 illustrate examples of display on the operation unit in the service mode according to the embodiment;

FIG. 13 is a flowchart showing job processing in the service mode according to the embodiment;

FIGS. 14 and 15 illustrate examples of display on the operation unit in the service mode according to the embodiment; and

FIG. 16 is a block diagram showing an example of the configuration of a power source system in the MFP according to the embodiment.

### DESCRIPTION OF THE EMBODIMENTS

Preferred embodiments of the present invention will now be described in detail in accordance with the accompanying drawings.

[System Configuration]

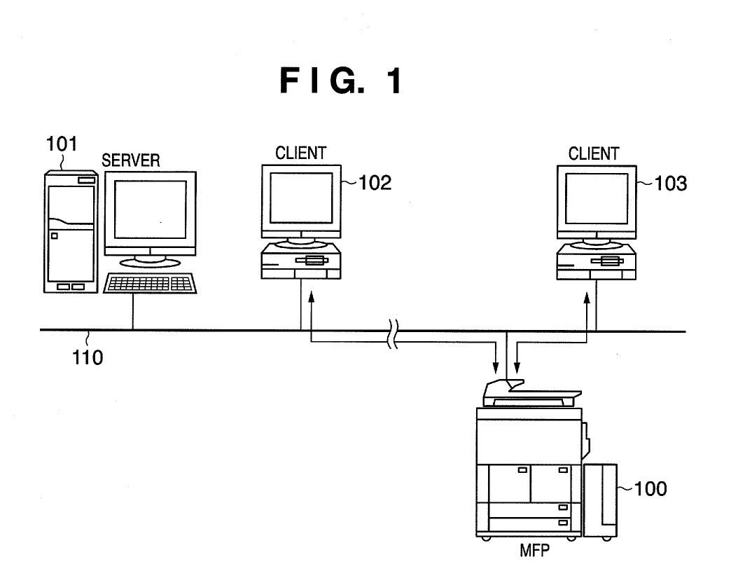

FIG. 1 is a block diagram showing the configuration of a print system according to an embodiment of the present invention. As shown in FIG. 1, image forming apparatuses) 100, print server(s) 101 and client PC(s) 102 and client PC(s) 103 are connected to a network 110.

The image forming apparatus 100, having various functions such as scanning, printing and copying functions, is called a multi function peripheral (MFP). Hereinbelow, in the present embodiment, a multi function peripheral is used as the image forming apparatus 100, and is referred to as an “MFP 100”.

The print server 101 has two roles. One role is transmission/reception of information with respect to an external device. For example, image information and setting information of a job to be inputted are first inputted into the print server 101. When the input job has been processed, the print server 101 notifies the external device of status information or the like. The other role of the print server 101 is management of the constituents of the system. The print server 101 performs unified management on jobs inputted from external devices, jobs occurred inside the MFP 100 and the like. The statuses of all the devices and all the jobs inside the MFP 100 can be monitored, job control such as temporary stoppage, setting change, print restart, duplication, movement, and deletion can be performed.

The client PCs 102 and 103 have a role of editing of an input application file, print instruction and input of print-ready file, and a role of monitoring and assistance of control of devices and jobs managed in the print server 101. The client PC 102 is used for job input. The client PC 102 also performs processing to transmit a printer driver, a direct print tool or the like to the MFP 100. The client PC 103 is used for execution of service maintenance. An application software program for service maintenance is installed in the client PC 103.

[Configuration of MFP 100]

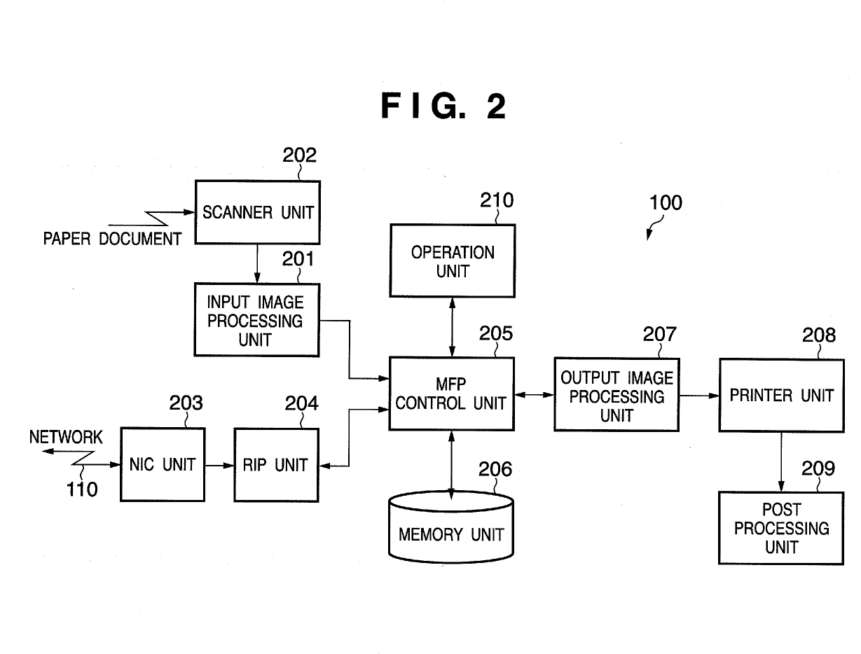

The configuration of the MFP 100 according to the present embodiment will be described with reference to FIG. 2.

In FIG. 2, an input image processing unit 201 reads a paper document (original) or the like using a scanner unit (image reading device) 202, performs image processing on the read image data, and delivers the data to an MFP control unit 205. An NIC (Network Interface Card) unit 203 connects the MFP 100 to the network 110. A print job (mainly PDL (Page Description Language) data) received from an external device (e.g., the print server 101) via the NIC unit 203 is sent to an RIP (Raster Image Processor) unit 204. The RIP unit 204 analyzes the received PDL data and performs processing to develop the data into an image or the like. Further, image data, device information and the like inside the MFP 100 are transmitted via the NIC unit 203 and the network 110 to the external device.

Image data outputted from the input image processing unit 201 and the RIP unit 204 is sent to the MFP control unit 205. The MFP control unit 205 plays a role of traffic controller to control input data and output data. The image data inputted into the MFP control unit 205 is temporarily stored into a memory unit 206. The image data stored in the memory unit 206 is read in accordance with necessity.

An output image processing unit 207 performs image processing for print output on image data, and sends the processed image data to a printer unit 208. The printer unit 208 feeds print sheets, and sequentially print-outputs the image data generated by the output image processing unit 207 on the sheets. The print-out sheets are sent to a post processing unit 209, and subjected to sheet assortment processing or sheet finishing processing.

An operation unit 210 is used for selection of the above-described various functions and for designation of operations. Note that in accordance with popularization of high-definition display device of the operation unit 210, it may be arranged such that image data in the memory unit is preview-displayed for checking, and if the preview image is OK, printing is performed.

As described above, the MFP 100 has various functions and usages, and examples of processing are as follows.

Copying function: input image processing unit 201→output image processing unit 207→printer unit 208

Network scanning: input image processing unit 201→NIC unit 203

Network Printing: NIC unit 203→RIP unit 204→output image processing unit 207→printer unit 208

Box scanning function: input image processing unit 201 →output image processing unit 207→memory unit 206

Box printing function: memory unit 206→printer unit 208

Box reception function: NIC unit 203→RIP unit 204→output image processing unit 207→memory 206

Box transmission function: memory unit 206→NIC unit 203

Preview function: memory unit 206→operation unit 210

[Structure of Operation Unit 210]

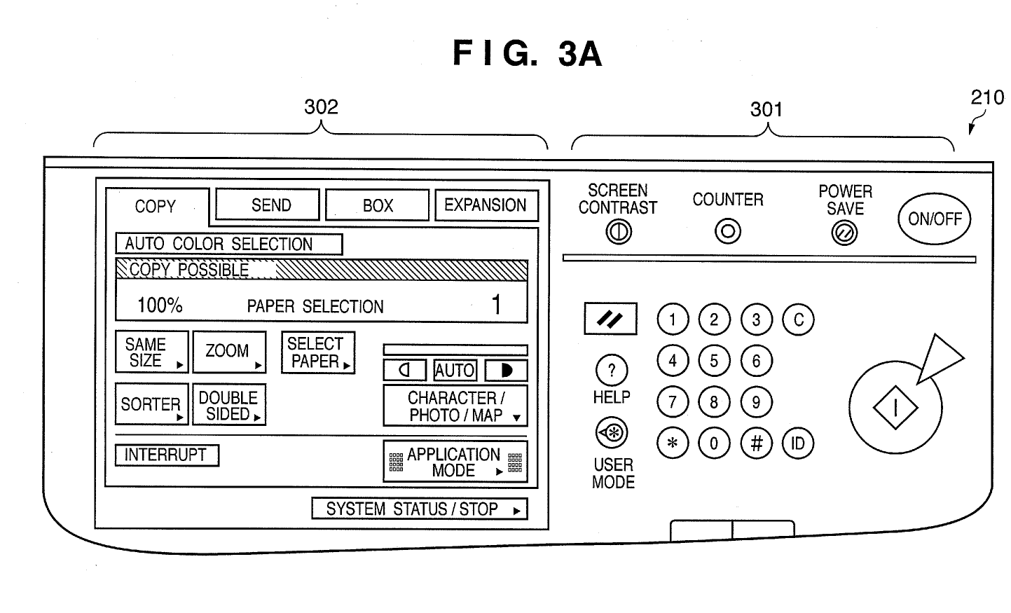

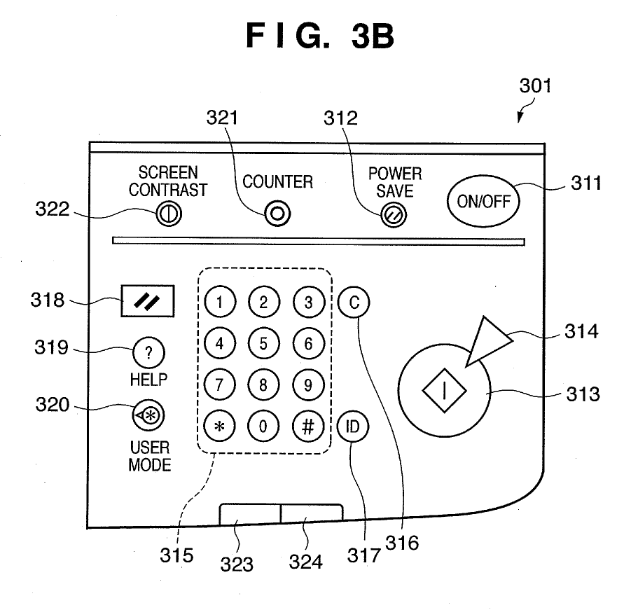

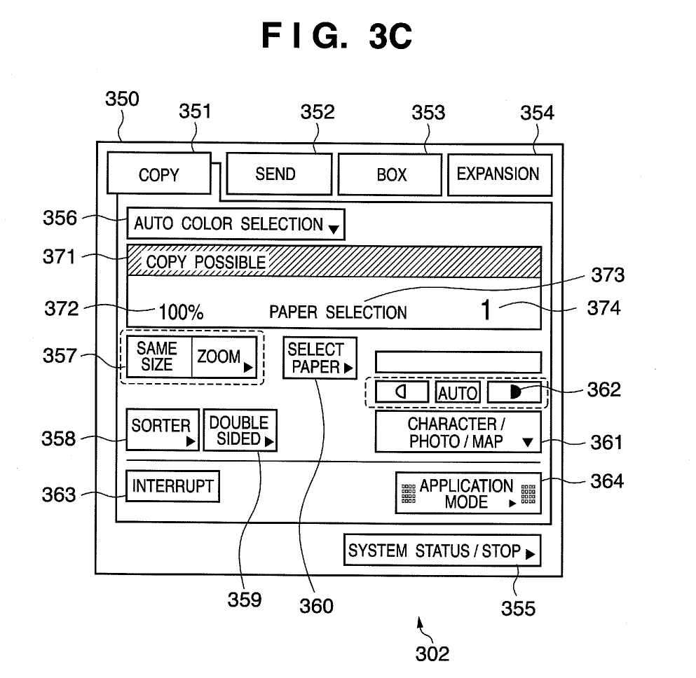

Next, the operation unit 210 of the MFP 100 according to the present embodiment will be described. FIGS. 3A to 3C illustrate an example of the operation unit 210 of the MFP 100. As shown in FIG. 3A, in the present embodiment, the operation unit 210 has a key input unit 301 and a touch panel unit 302. Hereinbelow, the details of the key input unit 301 and the touch panel unit 302 will be described with reference to FIGS. 3B and 3C.

FIG. 3B shows the details of the key input unit 301. The key input unit 301 is mainly used for stationary normal operation setting.

An operation unit power source switch 311 is used for switching between a stand-by mode (normal operation status) and a sleep mode. Note that the sleep mode means a status where a main controller stops a program in an interruption waiting state, in preparation for network printing, facsimile transmission or the like, thereby saves electric power consumption. The sleep mode is controlled by ON state of a main power source switch for power supply to the entire MFP 100.

A power save key 312 is used for selection of power save state where a fixing device control temperature is reduced in the stand-by mode, thereby electric power consumption is suppressed though warm-up time before print-ready state is increased. Note that the control temperature can be changed by setting of a power save rate. A start key 313 is used for instruction of start of copying, transmission or the like, and a stop key 314, used for stoppage of such operation. A numeric keypad 315 is used for input of numerals in various settings, and a clear key 316, used for cancellation of the input numerals. An ID key 317 is used upon input of predetermined security code for authentication of an operator of the MFP 100. A reset key 318 is used for invalidation of various settings and restoration of default state. A help key 319 is used for display of guidance, help or the like. A user mode key 320 is used for display of a system setup screen by user.

A counter checking key 321 is used for display of the number of outputted pages, stored in a software counter in the MFP 100 to count the number of print pages, on the display of the touch panel unit 302. Upon operation of the counter checking key 321, the number of outputted pages can be displayed in correspondence with a copy/print/scan/facsimile operation mode, a color/monochrome mode, a large/small paper size, and the like. An image contrast dial 322 is used for controlling screen viewability by controlling the backlight of the liquid crystal display of the touch panel unit.

An execution/memory lamp 323, which flashes during job execution, memory access or the like, is used for notification of the operation status of the MFP 100. An error lamp 324, which flashes upon job execution failure or occurrence of error requiring a service person call, or occurrence of error requiring an operator call such as paper jam, or shortage of consumables, is used for notification of such error.

FIG. 3C illustrates the LCD (Liquid Crystal Display) and the touch panel unit 302 having transparent electrodes attached on the LCD. The MFP control unit 205 is previously programmed to detect depression of a transparent electrode corresponding to a key displayed on the LCD by a finger and displays another operation screen or the like. Note that FIG. 3C shows a display example of an initial screen 350 in the stand-by mode, and various operation screens can be displayed in accordance with setting operation.

A copy tab 351 is a tab key for instruction to display a copy operation screen. A transmission tab 352 is a tab key for instruction to display an operation screen to designate a transmission (Send) operation in facsimile or E-mail transmission. A box tab 353 is a tab key for instruction to display a screen for input/output of job into/from a box (memory unit 206 for storage of job by user). An option tab 354 is a tab key for instruction to display an operation screen to set expanded functions such as scanner setting. When one of the tab keys is selected, a current mode is changed to the corresponding operation mode. A system monitor key 355 is used for instruction to display a screen informing the status or the like of the MFP 100.

A color selection setting key 356 is used for selection-instruction to previously select color copying, monochrome copying or automatic copy mode selection. A zooming setting key 357 is used for instruction to display a screen for setting of zooming such as the same-size, expansion or reduction. A post processing setting key 358 is used for instruction to display a screen for setting execution/nonexecution of stapling, punching, the number of stapling/punching, the position of stapling/punching and the like. A double sided setting key 359 is used for instruction to display a screen for selection of single-sided printing or double-sided printing. A paper selection key 360 is used for instruction to display a screen for selection of paper feeding tray, paper size and medium type. An image mode setting key 361 is used for selection of image mode appropriate to an original image such as a character mode or a picture mode. A density setting key 362 is used for deepening or thinning an image as output image density control.

A status display unit 371 is used for simple status display of a stand-by status, a warming-up status, a jammed status, an error status and the like. A zooming display unit 372 displays the zooming set with the zooming selection key 357. A paper size display unit 373 displays the paper size set with the paper selection key 360. Note that in FIG. 3C, as the automatic mode for automatically detecting a paper size is set, “auto paper selection” is displayed. A number of pages display unit 374 displays the number of pages designated with the numeric keypad 315, or displays a currently-processed page during printing. An interruption key 363 is used when a job is inputted during a copy operation. An application mode key 364 is used for instruction to display a screen for various image processings and layout settings such as continuous-page copying, front page/inserting paper setting, reduced layout, and image movement.

[Configuration of MFP 100]

The MFP 100 has a ID color system to form a color image using a single photoconductive drum.

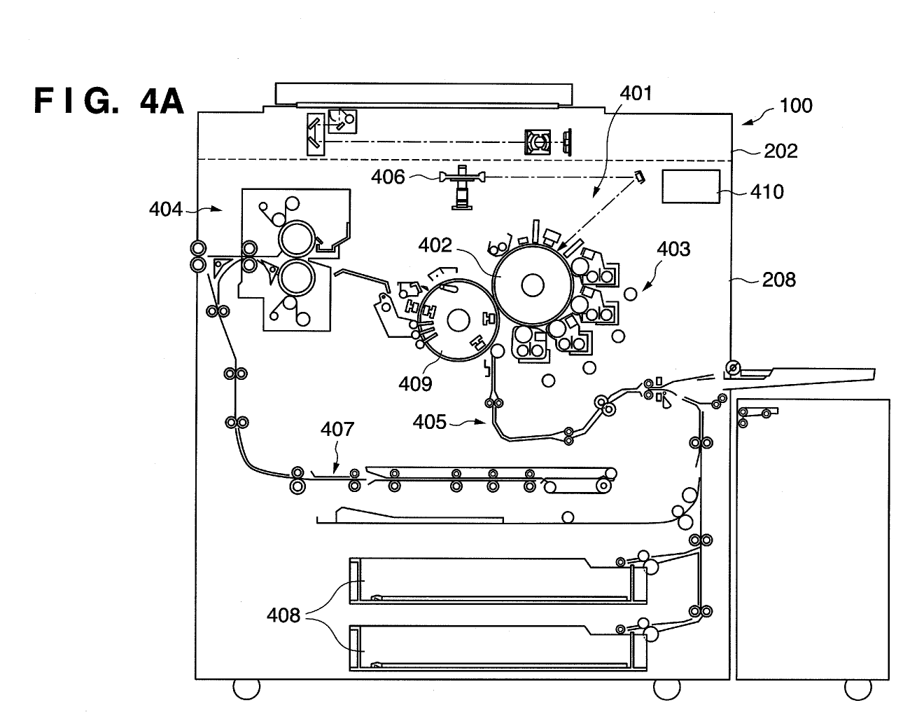

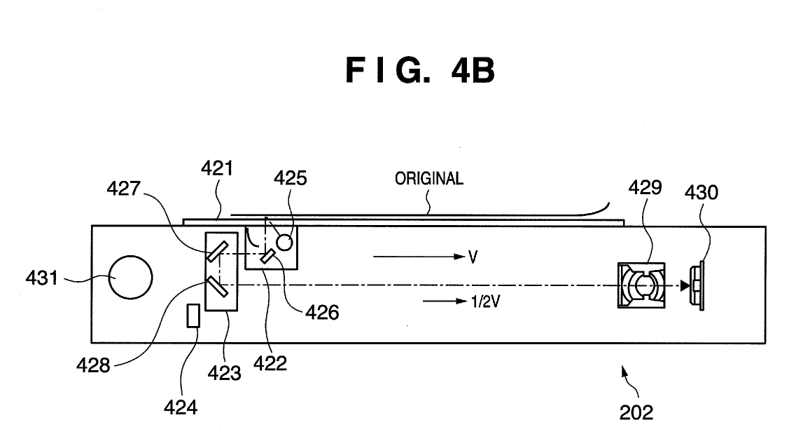

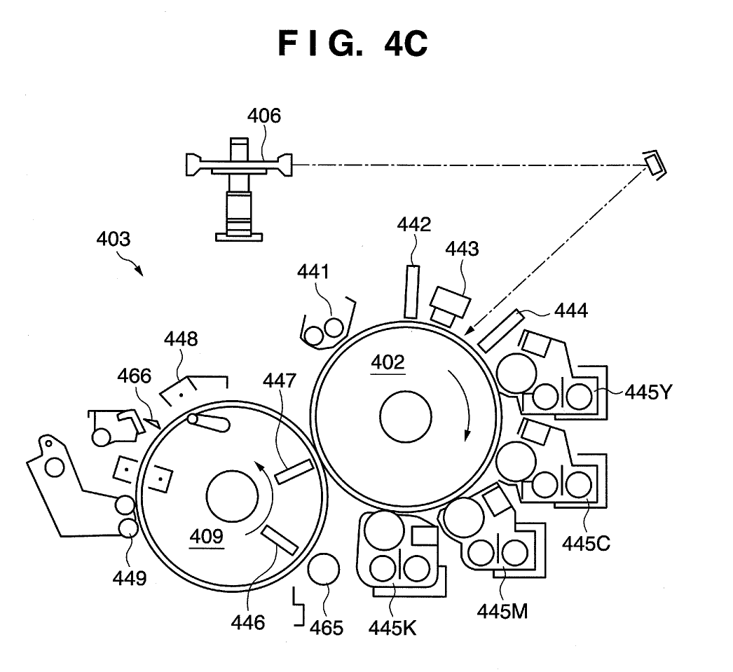

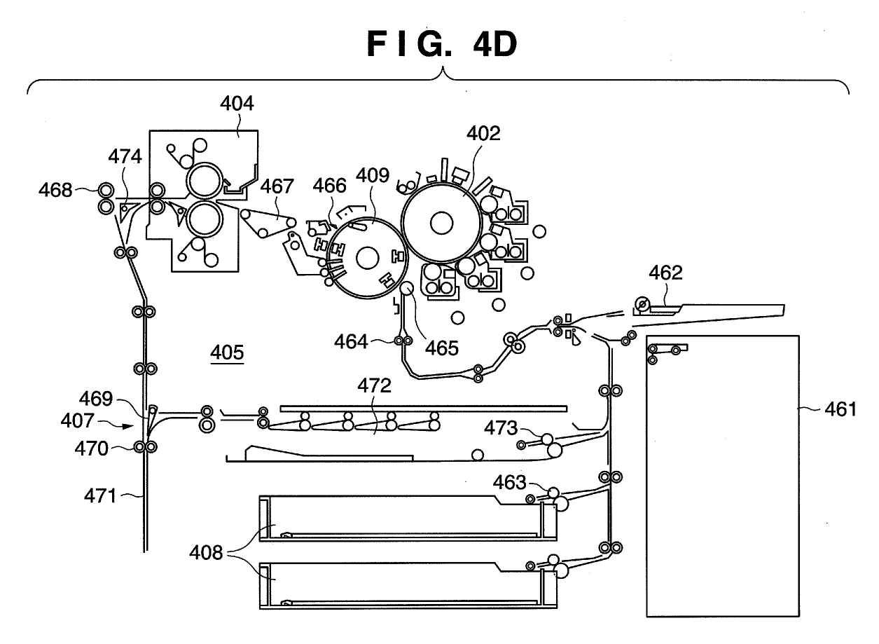

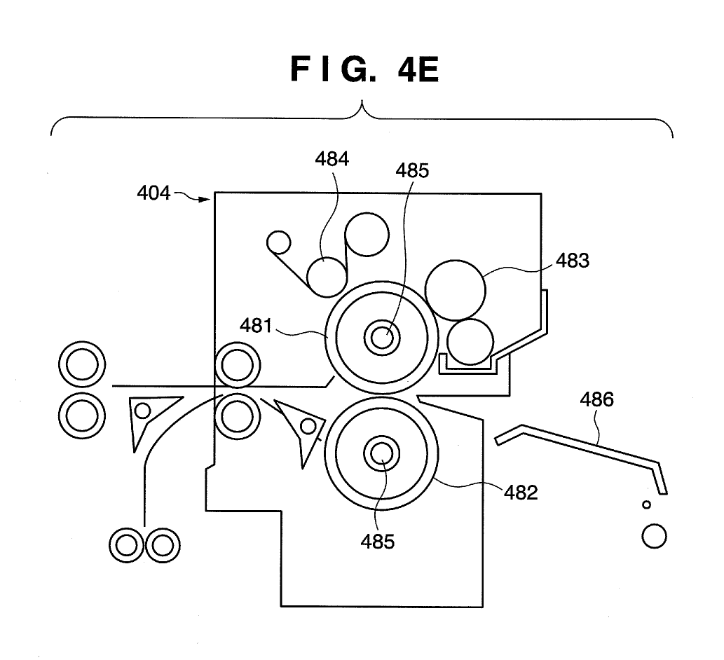

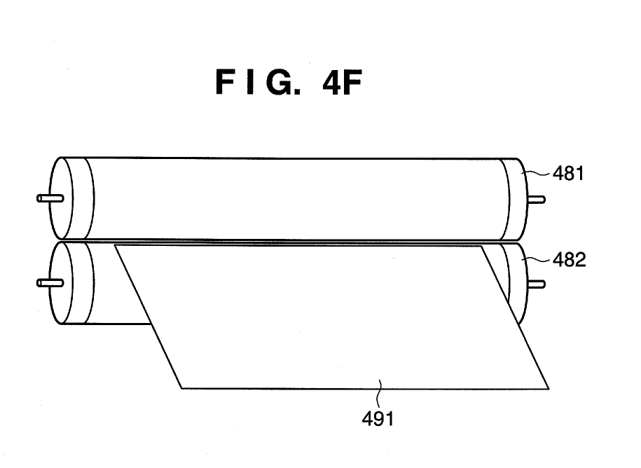

FIG. 4A schematically shows the structure of the MFP 100 according to the present embodiment. As described above, the MFP 100 has the scanner unit 202 and the printer unit 208. The scanner unit 202 emits light to an original placed on an original plate then optically reads the original image, converts the read image into an electric signal thereby generates image data.

The printer unit 208 has a 1-drum (1D) color system including a laser exposure unit 401, a photoconductive drum 402, an image generation unit 403, a fixing unit 404, a paper feed/conveyance unit 405 and a printer control unit 410 to control these units.

In the laser exposure unit 401, a light beam such as laser light, modulated in correspondence with image data, is reflected with a rotating polygon mirror (polygon mirror 406) rotating at a constant speed, and emitted as reflected scanning light on the photoconductive drum 402. The image generation unit 403 generates an image by performing a series of electrophotographic processes. In the electrophotographic processes, the photoconductive drum 402 is rotate-driven and is charged with a charger, then a latent image formed on the photoconductive drum 402 is developed with toner by the laser exposure unit 401, and the toner image is transferred onto a sheet. At that time, residual toner which has not been transferred to the sheet but remained on the photoconductive drum 402 is collected. The sheet is put on a predetermined position of a transfer drum 409, and while the transfer drum 409 rotates 4 times, the above-described electrophotographic processes are sequentially performed using developing units (developing stations) having magenta (M), cyan (C), yellow (Y) and black (K) toner. Note that the details of the processes will be described later. After the 4 rotations of the transfer drum 409, the sheet on which a 4-color (full color) toner image has been transferred is separated from the transfer drum and is conveyed to the fixing unit 404.

The fixing unit 404, having a combination of a roller, belt and the like, includes a heat source such as a halogen heater. The fixing unit 404 melts and fixes the toner of the toner image, generated by the image generation unit 403, onto the sheet by heat and pressure.

The paper feed/conveyance unit 405 has one or more sheet cassettes 408 represented by a sheet cassette or a paper deck. One of plural sheets set in the sheet cassette 408 is separated and conveyed to the image generation unit 403 and the fixing unit 404 in accordance with an instruction from the printer control unit 410. The sheet is put around the transfer drum 409 of the image generation unit 403, and after the 4 rotations of the transfer drum, conveyed to the fixing unit 404. While the transfer drum 409 rotates 4 times, the above-described YMCK toner images are transferred onto the sheet. Further, when image formation is performed on both sides of the sheet, the sheet is passed trough a double sided conveyance path 407 which conveys a sheet passed through the fixing unit 404 to the image generation unit 403 again.

The printer control unit 410 communicates with the MFP control unit 205 that controls the entire MFP 100, and performs control in correspondence with an instruction from the MFP control unit 205. The printer control unit 410 performs control such that the units in harmony with smoothly operate, while managing the statuses of the scanner unit 202, the laser exposure unit 401, the image generation unit 403, the fixing unit 404, the paper feed/conveyance unit 405 and the like.

[Operation of Printer Control Unit]

Next, the printer control unit 410 will be described.

The outline of the operations of the respective units from power-OFF status to operation-ready status are as follows. First, when the power source is turned ON, the printer control unit 410 instructs the scanner unit 202, the laser exposure unit 401, the image generation unit 403, the fixing unit 404 and the paper feed/conveyance unit 405 to start preparatory operation, and waits for start of communication with the MFP control unit 205 that manages the entire MFP 100. When the communication with the MFP control unit 205 has been established, information on specification of both apparatuses are transmitted between the printer control unit 410 and the MFP control unit 205. Thereafter, when the preparatory operations of the respective units have been completed and image forming operation is possible, the MFP control unit 205 is notified of the operation-ready status. The printer control unit 410 notifies the MFP control unit 205 of the statuses of the respective units. For example, the printer control unit 410 notifies the MFP control unit 205 of the size and the amount (capacity) of sheets held in the sheet cassette 408. Further, the printer control unit 410 detects the operation statuses (operative or broken) of the respective driving units of the paper feed/conveyance unit 405, and notifies the MFP control unit 205 of the detected statuses. Further, the printer control unit 410 detects the amounts of toner in the toner containers in the image generation unit 403 and notifies the MFP control unit 205 of the detected amounts.

Next, the outline of the operations of the respective units, in a status where the start of operation is possible, from notification of operation instruction from the MFP control unit 205 through execution of a series of print operations and the completion of the printing will be described.

First, the MFP control unit 205 notifies the printer control unit 410 of an operation start command. The printer control unit 410 receives the operation start command, and instructs the laser exposure unit 401, the image generation unit 403, the paper feed/conveyance unit 405 and the fixing unit 404 to start print operation. The laser exposure unit 401 starts rotation of a motor (polygon motor) to drive the polygon mirror 406. The image generation unit 403 rotate-drives the photoconductive drum 402 thereby charges the photoconductive drum 402. The fixing unit 404 turns a fixing heater ON to increase its temperature to a level to fix toner onto a print sheet. The paper feed/conveyance unit 405 brings its respective driving units (motors and the like) into a sheet-conveyable state.

In this manner, when the preparatory operations of the respective units have been completed, the printer control unit 410 notifies the MFP control unit 205 of the completion of preparation. The MFP control unit 205 receives the preparation completion notification from the printer control unit 410, and instructs to perform print operation by page. For example, when a print job for printing 20 copies of 10-page document exists, a print operation instruction for 200 pages is made. The printer control unit 410 receives the print operation instruction, and issues a paper feed instruction to the paper feed/conveyance unit 405. When sheets can be fed, the paper feed/conveyance unit 405 feeds one sheet and conveys it, and when the sheet arrives at a predetermined position, notifies the printer control unit 410 of the “sheet arrival at the predetermined position”. When paper feed is impossible because of shortage of sheet in the sheet cassette 408 or the like, the paper feed/conveyance unit 405 notifies the printer control unit 410 of the “paper feed impossible” status.

Further, the paper feed/conveyance unit 405 may be provided with a multi-feed detection sensor to detect conveyance of sheets in an overlapped state or a thickness detection sensor to detect the thickness of sheet(s) on the conveyance path. When the sensor has detected abnormality such as multi-feed or abnormal thickness, the paper feed/conveyance unit 405 suspends the paper feed operation and the conveyance operation, and notifies the printer control unit 410 of the abnormality. In such case, the printer control unit 410 notifies the MFP control unit 205 of the reason of operation suspension, the position of the sheet remaining in the apparatus and the like. When the sheet has been normally conveyed and arrived at the predetermined position, the printer control unit 410 instructs the image generation unit 403 to start image generation in correspondence with the notification of the “sheet arrival at the predetermined position” from the paper feed/conveyance unit 405. By this timing control, a toner image is transferred to an appropriate position on the sheet.

The fixing unit 404 monitors the temperature of the fixing roller, and controls to keep an appropriate fixing temperature. Note that when the amount of heat absorbed by the sheet from the fixing unit 404 is large, the temperature of the fixing unit 404 may be lowered. In this case, the fixing unit 404 notifies the printer control unit 410 of the reduction of the temperature of the fixing unit 404. The printer control unit 410 receives the notification, then increases a sheet conveyance interval so as not to reduce the temperature of the fixing unit. When the appropriate temperature of the fixing unit 404 cannot be restored, the printer control unit 410 suspends the print operation, and when the appropriate temperature of the fixing unit 404 is restored, restarts the print operation. When the discharge of all the sheets to be discharged has been completed, the printer control unit 410 instructs the respective units to stop their operations, and then, receives the notifications of operation stoppage from the respective units, and notifies the MFP control unit 205 of the completion of print operation.

[Structure of Scanner Unit]

FIG. 4B is a cross-sectional view showing the structure of the scanner unit 202. In FIG. 4B, an original to be read is placed on an original plate glass 421. The scanner 202 starts a scanning operation, with depression of the start key 313 on the operation unit 210 or clicking of an OK key of the scanner driver as a trigger.

In the scanner unit 202, when the scan operation has been started, a first mirror unit 422 and a second mirror unit 423 temporarily return to a home position detected by a home position sensor 424. Then an original illumination lamp 425 in the first mirror unit 422 is turned ON, thereby light is emitted on the original. The light reflected from the original is reflected with a first mirror 426 in the first mirror unit 422, a second mirror 427 in the second mirror unit 423 and a third mirror 428, and image-formed through a lens 429 on a CCD sensor 430. Thus, an optical signal corresponding to the original on the original plate glass 421 is inputted into he CCD sensor 430.

The first mirror unit 422 and the second mirror unit 423 are driven by the same original scanner motor 431. Note that by application of movable block, when the first mirror unit 422 moves at a velocity (V), the second mirror unit 423 moves at a velocity (V/2) about the half of the velocity (V), thus they scan the whole surface of the original.

[Structure of ADF Unit]

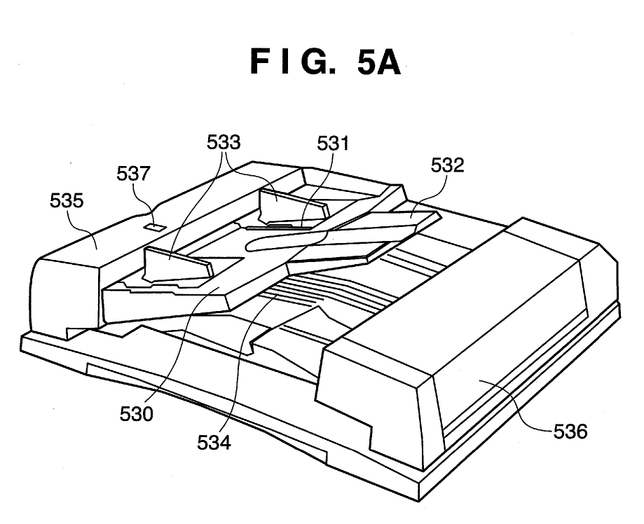

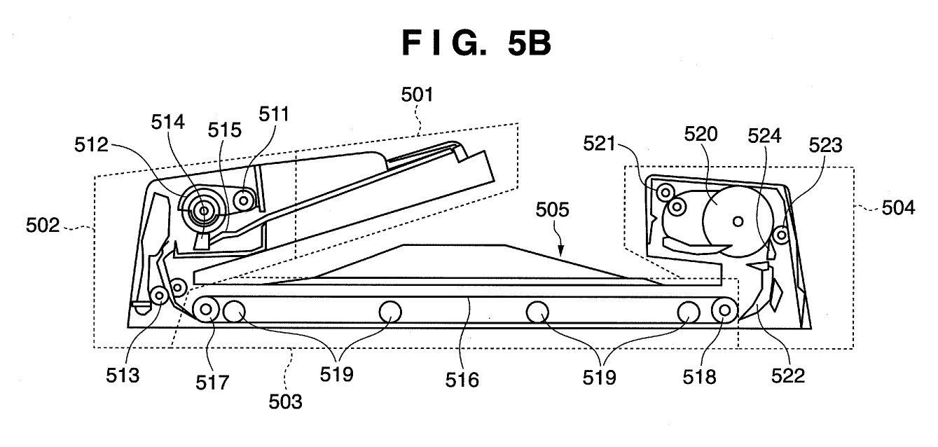

FIGS. 5A and 5B are perspective view and cross-sectional view showing the structure of the automatic document feeder (ADF) unit. An original stacking unit 501 (FIG. 5B) includes an original tray 530, an original detection sensor 531, an original auxiliary tray 532 and a slide guide 533. When an original is set on a stacking surface of the original tray 530, the original detection sensor 531 detects the original. The original detection sensor 531 is provided between a pickup roller 511 and paper feed roller 512 to be described later.

A paper feed unit cover 535 covers the constituents of an original paper feed unit 502 to be described later. Further, a paper reverse and discharge unit cover 536 covers the constituents of a paper reverse and discharge unit 504 to be described later. An original set display 537 is turned ON when the original detection sensor 531 detects the presence of an original on the original tray 530.

The original paper feed unit 502 separates a top sheet from an original budget by friction separating, one by one, and conveys the sheet to registration rollers 513. When the original is fed, the pickup roller 511 is moved downward above the original budget, and an intermediate plate (rifter 515) rises to press the original budget against the paper feed roller 512, as a paper-feed preparatory operation. Then, the paper feed roller 512 and the pickup roller 511 rotate in a CW (Clock Wise) direction by a motor as a driving source, to convey the original. The second top and the subsequent original documents, following the picked up top original, are stopped with a friction piece (separation pad 514), and remain in the original stacking unit 501. The separation of original is detected by a separation sensor (not shown) provided downstream of the paper feed roller 512.

Thereafter, the original passes through guide plates, and introduced to the pair of registration rollers 513. The registration rollers 513 are stopped upon arrival of the end of the original, and the original is formed into a loop by conveyance with the paper feed roller 512. By this loop formation, skew correction is performed, and the skew-corrected original is conveyed to an original conveyance unit 503. The original conveyance unit 503 has a conveyance belt 516 put around a driving roller 517 and a driven roller 518. The conveyance belt 516 is rotated while it is pressed against the platen (original plate glass 421) with pressing rollers 519. When the original enters between the conveyance belt 516 and the platen, it is conveyed on the platen by a frictional force of the conveyance belt.

When the original, entered the original conveyance unit 503 from the original paper feed unit 502, is conveyed with the conveyance belt 516 to a predetermined position on the platen, the conveyance is stopped in accordance with stoppage of a driving motor (not shown), and the original is read with the scanner unit 202. When the reading has been completed, the original is conveyed in a rightward direction in FIG. 5B by restart of the driving motor, and introduced to the paper reverse and discharge unit 504. When a subsequent original document exists, the subsequent original is conveyed to the reading position of the scanner unit 202 by the above-described operations and is read. While the subsequent original is read, the preceding original is reversed by the paper reverse and discharge unit 504 which operates independently, and is conveyed to a paper discharge stacking unit 505.

The document reverse and discharge operation will be described. The paper reverse and discharge unit 504 has a reverse roller 520 and a pair of conveyance rollers 521 as conveyance members, and a motor (not shown) as a driving source of these members. The motor is rotatable in forward and reserve directions. Thus, the paper reverse and discharge unit 504 can be driven independently of the original conveyance unit 503 driven by another motor.

Next, the original discharge operation by the paper reverse and discharge unit 504 will be described. When the original enters the paper reverse and discharge unit 504 with the conveyance belt 516, a reverse flapper 522 to regulate a paper traveling path around the entrance of the paper reverse and discharge unit 504 moves to a position as shown in FIG. 5B by the control of a solenoid (not shown). In this status, the original is introduced to the reverse roller 520. Then the original is held between the reverse roller 520 rotating CCW (Counter Clock Wise) and a reverse roller 523 opposing to the reverse roller 520, and is conveyed to the conveyance roller 521.

When the rear end of the original arrives at a position out of a paper discharge flapper 524, the paper discharge flapper 524 rotates in the CW direction, and the reverse roller 520 reverse-rotates in the CW direction, to start switch-back conveyance of the original. Thus the original is introduced to a position left and below the reverse roller 520, and is discharged to an original discharge tray 534.

[Structure of Image Generation Unit 403 in 1D Color System]

FIG. 4C is a cross-sectional view showing the schematic structure of the image generation unit 403 to form a color image using one photoconductive drum (1D). In FIG. 4C, the photoconductive drum 402 rotates rightwise in accordance with output instruction information. Next, the constituents will be sequentially described from a cleaner unit 441.

The cleaner unit 441 collects toner attached to the photoconductive drum 402 thereby cleans the surface of the photoconductive drum. A pre exposure LED 442 is used for elimination of residual charge on the photoconductive drum. A primary charger 443, having a discharging device called a grid, sets the drum surface potential to a predetermined potential. A potential sensor 444 measures the surface potential of the photoconductive drum 402. The potential sensor 444 measures a portion irradiated with laser (VI) and unexposed primary charging potential (Vd). After the power-ON of the MFP 100, at a predetermined timing, e.g., upon output of predetermined number of sheets, the surface potential of the photoconductive drum 402 is measured using the potential sensor 444. Then, the quantity of laser light, charging bias, developing bias and the like are corrected based on the result of measurement.

In the present embodiment, four developing units (445Y to 445K), for Yellow, Cyan, Magenta and Black color, are arranged rightwise. In this arrangement, yellow toner is used in the first color image formation. The developing units 445 are respectively brought into contact with the photoconductive drum 402 at predetermined timing, and form a toner image in accordance with a latent image formed on the surface of the photoconductive drum 402. On the other hand, a print sheet is fed and conveyed at predetermined timing, and attached to the transfer drum 409 charged with an attachment charger 446. Then, the toner image on the photoconductive drum 402 is electrostatically-transferred onto the sheet attached on the transfer drum 409 by a transfer charger 447. Then, the process proceeds to the next color.

The above processing is repeated for the second color (Cyan), the third color (Magenta) and the fourth color (Black). The sheet where the black toner image has been transferred is separated from the transfer drum 409 with a separation charger 448 and a separation claw 466, and is sent to the fixing unit 404. As described above, in the fixing unit 404, the supplied sheet is pressed and heated, thereby the toner image is fixed to the sheet. Thereafter, the sheet is discharged to the outside of the apparatus main body. The transfer drum 409 is cleaned with a fur brush 449 in preparation for the next job.

[Structure of Paper Feed/Conveyance Unit of 1D Color System MFP]

Next, the paper feed/conveyance unit 405 will be described with reference to FIG. 4D.

The paper feed/conveyance unit 405 has the sheet cassette 408 and a paper deck 461, a manual feed tray 462, paper feed rollers 463 and registration rollers 464. Print sheets in various sizes and various materials are stored in the paper cassette 408 and the paper deck 461. Further, various recording sheets including films such as OHP sheets are stacked on the manual feed tray 462. The sheet cassette 408, the paper deck 461 and the manual feed tray 462 are respectively provided with a paper feed roller (463) for sheet feeding by one sheet. More particularly, the stacked sheets are sequentially fed with a pickup roller and sent to a conveyance guide one by one while multi-feed is prevented with a separation roller opposing to the paper feed roller. Note that a driving force to rotate the separation roller in an opposite direction to the conveyance direction is inputted into the separation roller via a torque limiter (not shown). When only one sheet exists in a nip portion formed with respect to the paper feed roller, the separation roller rotates in the conveyance direction in accordance with the sheet. On the other hand, when multi-feed has occurred, the separation roller rotates in the opposite direction to the conveyance direction, thereby the overlapped sheet is returned, and only the top sheet is sent. Note that the above arrangement is well known, and a particular illustration will be omitted.

The sheet is sent between conveyance guides, and conveyed with plural conveyance rollers to the registration rollers 464. At this time, the registration rollers 464 are stopped, and when the end of the sheet abuts on a nip portion formed with the pair of registration rollers 464, the sheet is formed into a loop. This mechanism corrects skew of the sheet. Thereafter, at the timing of toner image formation on the photoconductive drum 402 in the image generation unit 403, the registration rollers 464 start rotation to convey the sheet.

As described in FIG. 4C, the sheet sent with the registration roller 464 is electrostatically attached to the surface of the transfer drum 409 by the attachment roller 465 and the attachment charger 446. On the other hand, the toner image has been formed in accordance with the predetermined process on the photoconductive drum 402. The sheet attached to the transfer drum 409 is conveyed in accordance with the rotation of the transfer drum 409. Then, in a position opposite to the photoconductive drum 402, a high voltage is applied by a transfer charger 447, thereby the toner image on the photoconductive drum 402 is electrostatically transferred onto the surface of the sheet. Upon formation of a color image, the sheet on the transfer drum 409 is further rotated, and toner images for CMYK colors are transferred.

The sheet subjected to the above transfer processing is separated from the transfer dram 409 with the separation claw 466, and conveyed with a fixing pre-conveyance unit 467 to the fixing unit 404. The fixing pre-conveyance unit 467 has a rubber belt put around plural rollers and a suction fan (not shown). The sheet is sucked with the suction fan to the rubber belt side, and conveyed with the rubber belt rotated by a driving source (not shown). In the fixing unit 404, the toner image is pressed and heated and fixed to the sheet. The sheet is sent to a discharge unit.

The discharge unit has a paper discharge flapper 474 and paper discharge rollers 468. The paper discharge flapper 474, swingable about a swing shaft, regulates a sheet conveyance direction. When the paper discharge flapper 474 swings in a clockwise direction in the figure, the sheet is conveyed straight forward, and discharged with the paper discharge roller 468 to the outside. On the other hand, when image formation is made on both sides of the sheet, the paper discharge flapper 474 swings in a counterclockwise direction in the figure, and the sheet conveyance direction is changed to a downward direction, and is sent to the double sided conveyance path 407.

The double sided conveyance path 407 has a reverse flapper 469, reverse rollers 470, a reverse guide 471 and double sided tray 472. The reverse flapper 469, swingable about a swing shaft, regulates a sheet conveyance direction. First, the reverse flapper 469 swings in the counterclockwise direction in the figure, and the sheet is sent with the reverse rollers 470 to the reverse guide 471. In a state where the rear end of the sheet is held with the reverse rollers 470, the reverse rollers 470 temporarily stop, and the reverse flapper 469 swings in the clockwise direction in the figure. In this status, when the reverse roller 470 rotates in an opposite direction, the sheet is switch-back conveyed, with its rear end as a front end, and guided to the double sided tray 472.

The sheet is temporarily stacked on the double sided tray 472, thereafter, the sheet is again sent with the paper re-feed roller 473 to the registration rollers 464. At this time, the opposite side of the sheet to the first side subjected to the previous transfer processing is opposite to the photoconductive drum 402. Then, an image is formed on the second side through a similar process to that described above. Thus images have been formed on the both sides of the sheet, and the sheet is discharged through the fixing unit 404 to the outside.

[Structure of Fixing Unit of MFP]

FIG. 4E schematically shows the structure of the fixing unit 404 of the MFP 100.

A recording medium passed through the conveyance guide 486 is conveyed to the fixing unit 404. The fixing unit 404 presses and feats a toner image thereby fixes the toner image to the recording medium. The fixing unit 404 has a rotatable fixing roller 481, a pressure roller 482 rotating in contact with the fixing roller 481, an oil coating device 483 and a cleaning device 484.

A heater 485 such as a halogen lamp is provided inside the fixing roller 481 and the pressure roller 482. The cleaning device 484 cleans toner or the like offset on the surface of the fixing roller 481. The oil coating device 483 coats the surface of the fixing roller 481 with silicon oil or the like as mold lubricant. The oil coating by the oil coating device 483 facilitates separation of recording medium from the fixing roller 481, and the cleaning device 484 prevents toner offset.

FIG. 4F shows a sheet 491 passing through the fixing unit 404. The fixing unit 404, having the fixing roller 481 on its upper side and the pressure roller 482 on the lower side, heats and presses the sheet 491 with these rotatable rollers, thereby fixes a toner image to the sheet. The sheet 491 passes through around the center of the fixing roller 481 and the pressure roller 482.

[Structure of Post Processing Unit]

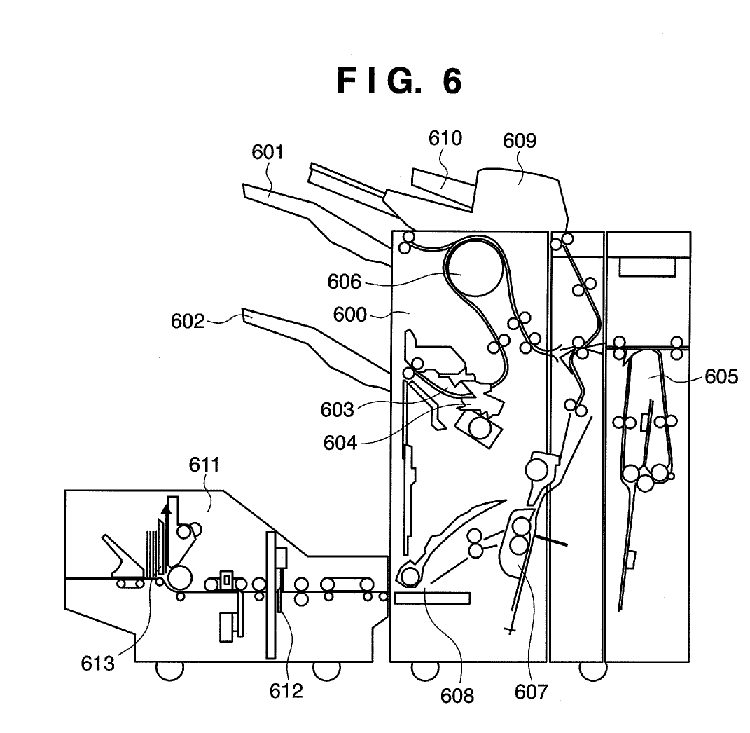

FIG. 6 is a cross-sectional view showing the structure of an in-line finisher unit 600. The in-line finisher unit 600 as shown in FIG. 6 is connected to the paper discharge side of the printer unit 208 shown in FIG. 4A such that various post processings can be performed. When the in-line finisher is connected, a sheet discharged from the fixing unit 404 of the printer unit 208 enters the in-line finisher unit 600. The in-line finisher unit 600 has a sample tray 601 and a stack tray 602 selectively used upon discharging in correspondence with job type or number of discharged sheets.

As sorting, bin sorting and shift sorting are employed. In the bin sorting, recorded sheets are sorted to plural bins. In the shift sorting, output sheets are sorted by job with an electronic sort function and shift operation of bins (or trays) in frontward-rearward directions. Note that in the electronic sort function, the function of electronic sorting can be supported by using a so-called collate function of, as long as a large capacity memory is provided in a core, changing the order of buffered pages and discharge order utilizing the buffer memory. Further, a group function means sorting by page, different from job-based sorting.

Further, when a staple mode is set for a job to be outputted, output is controlled to discharge sheets onto the stack tray 602. At this time, prior to discharge of the sheets onto the stack tray 602, the sheets are sequentially stored by job on a process tray 603 inside the finisher, then the sheets by job are bound with a stapler 604 on the process tray 603, then the sheet budget is discharged onto the stack tray 602.

Further, in addition to the above two trays 601 and 602, the in-line finisher unit 600 is provided with a Z-folding unit 605 to fold a sheet in z shape and a puncher 606 to punch two (or three) holes for filing, selectively used in correspondence with job type. For example, when a user has set the Z-folding processing via the operation unit 210 regarding sheet processing of a job to be outputted, the Z-folding processing is performed by the Z-folding unit 605 on a print sheet of the job. Then, the Z-folding processed sheet is passed through the in-line finisher unit 600 and discharged onto the discharge tray such as the stack tray 602 or the sample tray 601. Further, when the user has set punch processing via the operation unit 310 regarding sheet processing of a job to be outputted, the punch processing is performed by the puncher 606 on a print sheet of the job. Then the punch-processed sheet is passed through the in-line finisher unit 600 and discharged onto the discharge tray such as the stack tray 602 or the sample tray 601.

Further, a saddle stitcher 607 binds sheets in two positions about the central portion, then inserting the central portion under a roller thereby center-folding the sheets into halves, thus forming a pamphlet-like booklet (bookbinding). The sheets bookbind-processed with the saddle stitcher 607 are discharged on to a booklet tray 608. The permission/prohibition of execution of the sheet processing such as the above bookbinding using the saddle stitcher is also set based on the sheet processing setting made by the user with respect to a job to be outputted.

Further, an inserter 609 is used for sending a sheet set on an insert tray 610 to any of discharge tray such as the stack tray 602 and the sample tray 601 without the printer. The sheet set in the inserter 609 can be inserted between sheets sent to the in-line finisher unit 600 (sheets print-processed in the printer unit 208). In the insert tray 610 of the inserter 609, sheets are set in faced-up state by the user, and sequentially fed with a pickup roller from the top sheet.

Accordingly, the sheet from the inserter 609 is conveyed to the stack tray 602 or the sample tray 601, and discharged in faced-down state. Further, when the sheet is sent from the insert tray 610 to the saddle stitcher 607, the sheet is sent to the puncher 606 side then switch-back conveyed to the saddle stitcher 607, thereby the orientation of the face of the sheet is corrected. Further, the permission/prohibition of execution of the sheet processing such as the above sheet inserting using the inserter 609 is also set based on the sheet processing setting made by the user with respect to a job to be outputted.

Next, a trimmer (cutting unit) 611 will be described.

An output formed in a booklet (saddle-stitched pamphlet) by the saddle stitcher 607 enters the trimmer 611. At this time, the output booklet is fed by a predetermined length with a roller, and cut with a cutter unit 612. Thus, sheet ends of plural pages of the booklet are sheared. Thereafter, the booklet is stored into a booklet hold unit 613. Note that the permission/prohibition of execution of the sheet processing such as the above cutting using the trimmer 611 is also set based on the sheet processing setting made by the user with respect to a job to be outputted.

[Printer Driver Setup Screen]

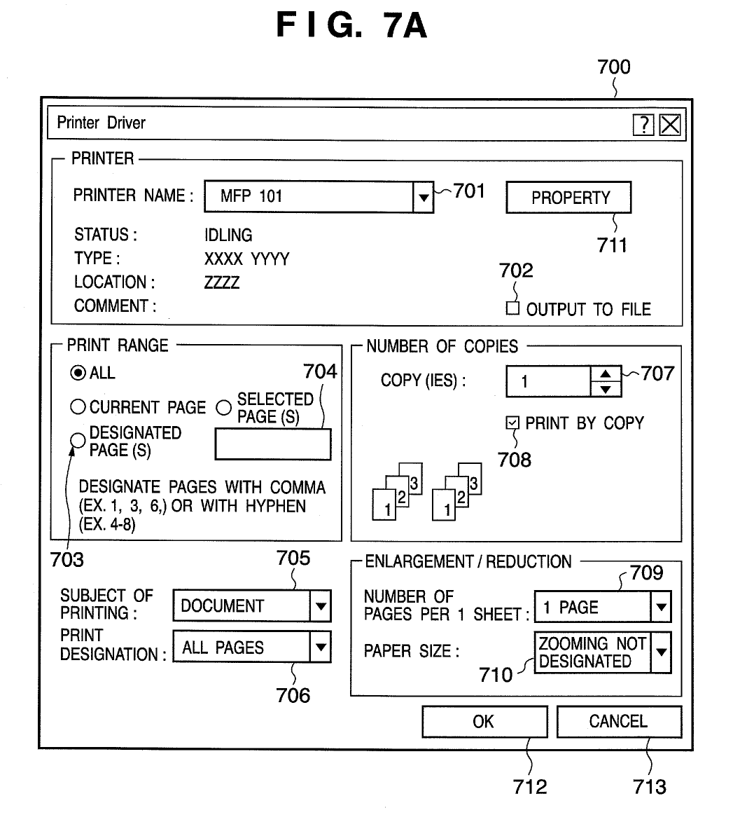

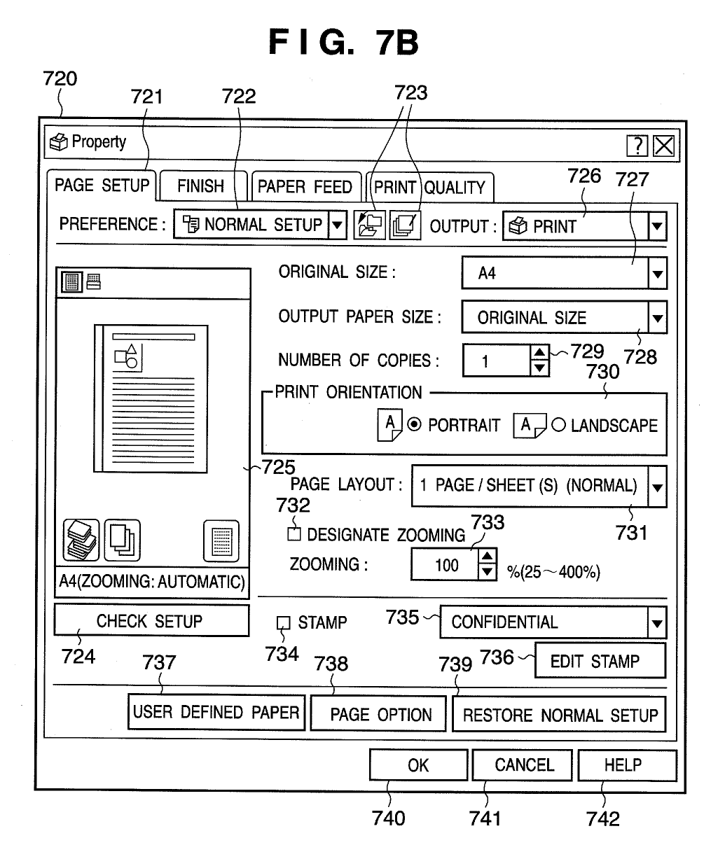

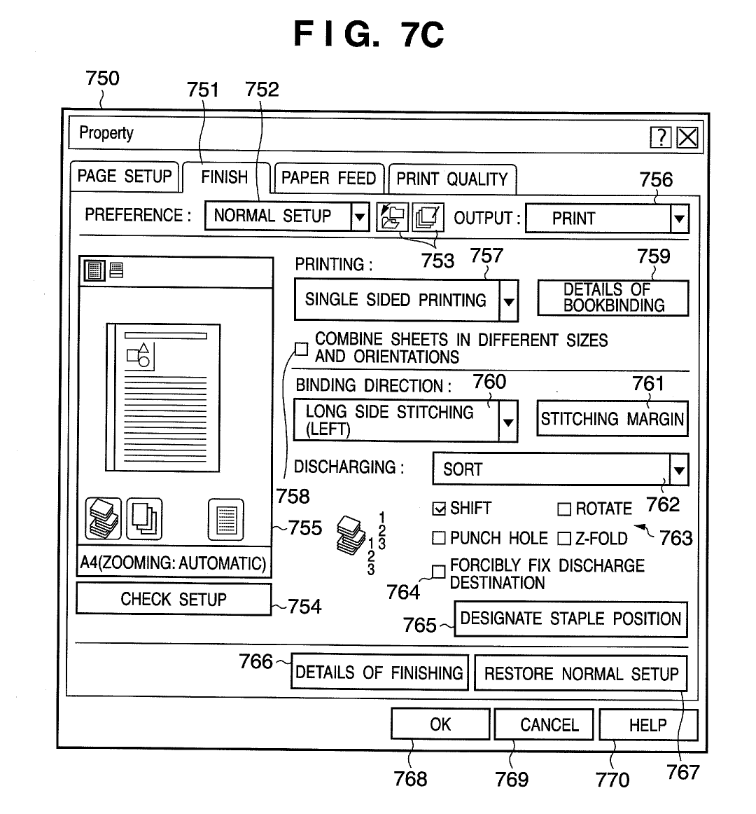

A printer driver is used as a means for print-output from a print application operating on the client PC 102 to a print device the MFP 100. FIG. 7A shows an example of printer driver setup screen of the printer driver operating on the client PC 102. When an operator is to print-output print data from a print device such as the MFP 100, the printer driver setup screen is displayed by the operator's selecting a print menu of a print application.

The operator can select a print device to be used using a “printer name” pull-down list box 701 in a setup screen 700. When a printer to be used has been selected, the status of the print device is displayed in space “status” below the printer, the type of the printer driver is displayed in space “type”, the installation location information of the print device is displayed in space “location”, and comment information from a print device administrator is displayed in space “comment”. When print data is to be outputted to a file without print-output by the print device, a check box “output to file” 702 is selected.

In space “print range”, one of “all”, “current page”, “selected page(s)” and “designated page(s) is selected using a radio button 703, thereby page(s) to be print-outputted is designated. When the “designated page(s) is selected, page number(s) to be print-outputted is inputted in an edit box 704.

Further, the attribute of document as the subject of printing is selected using a “subject of printing” pull-down list box 705. Further, whether all the pages, only odd-numbered pages or only even-numbered pages are to be printed, is designated by using a “print designation” pull-down list box 706.

In space “number of copies”, the number of copies to be print-outputted is inputted in a “number of copies” spin box 707. Further, when plural copies are to be printed not by page but by copy, a “print by copy” check box 708 is selected.

In space “expansion/reduction”, the number of pages per page is designated in N-up printing (plural pages are laid out in one print area) by using a “number of pages per 1 sheet” pull-down list box 709. Further, a paper size with respect to an original size is selected by using a “paper size” pull-down list box 710.

Further, by depression of a “property” button 711, detailed print attributes can be set.

When the operator has completed the setting in the printer driver setup screen, the operator depresses an “OK” button 712, thereby print data is transmitted to a print device such as the MFP 100, and printing is performed. Otherwise, when an “output to file” check box 702 is checked, the print data is outputted to a file by the depression of the “OK” button 712. By the depression of a “cancel” button 713, the print output or file output is cancelled.

FIG. 7B shows an example of a property setup screen related to the printer driver page setting processing. In FIG. 7B, a page setup screen 720 as one property setup screen is shown. The page setup screen 720 is displayed by selecting a page setup tab 721 in a property setup screen displayed by depression of the property button 711 in the setup screen 700 shown in FIG. 7A. Note that the page setup screen 720 may be displayed as a default screen upon depression of the property button 711 in the printer driver setup screen 700.

In a “preference” pull-down list box 722, an optimum page setting is selected from predetermined page setting modes. Preference items can be added or edited by using two buttons 723 positioned right side of the list box 722. Further, by depression of a “check setup” button 724, the contents set in the property setup screen can be list-displayed. The contents set in the property setup screen are reflected in a page image 725 displayed above the list display.

In an “output” pull-down list box 726, an output method in the print device such as the MFP 100 is designated. As available output methods, “normal printing”, “secure printing”, “store on hard disk of print device”, “edit and preview on print device” and the like are used.

In “original size” and “output paper size” pull-down list boxes 727 and 728, the size of original as the subject of printing and the size of paper outputted from the print device can be selected. The number of copies to be print-outputted is designated by using a “number of copies” spin box 729. Further, the orientation of output sheet such as “portrait” or “landscape” in the print device can be selected by using a “print orientation” radio button 730.

In a “page layout” pull-down list box 731, N-up print (plural pages are laid out in one print area) can be designated. Further, when a “designate zooming” check box 732 is selected, the scale of enlargement/reduction is set by % in a “zooming” spin box 733.

When a “stamp” check box 734 is selected, one of predetermined stamp types can be selected by using a pull-down list box 735. Further, by depression of an “edit stamp” button 736, stamp type(s) can be added and edited.

By depression of a “user defined paper” button 737, user's defined paper can be set. By depression of a “page option” button 738, further detailed page options can be set. Further, by depression of a “restore normal setup” button 739, these settings can be set to default settings.

When the operator has completed the setting in the printer driver property setup screen, by depression of an “OK” button 740, these print attributes can be reflected in actual printing. When the settings in the property setup screen are to be cancelled, a “cancel” button 741 is depressed. Further, a “help” button 742 displays a help screen for explanation of the property setup screen.

FIG. 7C shows an example of a printer driver property setup screen related to finishing processing. A printer driver finishing setup screen 750 is displayed by selecting a “finish” tab 751 in the printer driver property setup screen.

In a “preference” pull-down list box 752, an optimum page setting is selected from predetermined page setting modes. “Preference” items can be added or edited by using two buttons 753 positioned right side of the list box 752.

Further, by depression of a “check setup” button 754, the contents set in the property setup screen can be list-displayed. The contents set in the property setup screen are reflected in a page image 755 displayed above the list display.

In an “output” pull-down list box 756, an output method in the print device such as the MFP 100 is designated. As available output methods, “normal printing”, “secure printing”, “store on hard disk of print device”, “edit and preview on print device” and the like are used.

In a “printing” pull-down list box 757, a printing method such as “single sided-printing”, “double sided printing” or “bookbinding printing” is selected. When sheets in different sizes and/or orientations are combined, a “combine sheets in different sizes/orientations” check box 758 is selected, and the combination of sheets and the binding margin are designated. In the “printing” pull-down list box 757, when “bookbinding printing” is selected, a “details of bookbinding” button 759 is depressed, and the method of bookbinding printing, the page opening direction and the binding margin are designated. Further, when “single sided printing” or “double sided printing” is selected in the “printing” pull-down list box 757 and the “combine sheets in different sizes/orientations” check box 758 is not selected, the binding direction is designated. That is, in a “binding direction” pull-down list box 760, “long side stitching (left)”, “long side stitching (right)”, “short side stitching (left)”, “short side stitching (right)” or the like is selected, and a “stitching margin” button 761 is depressed and the stitching margin is designated.

In a “discharging” pull-down list box 762, discharging such as “sort”, “group” or “staple” is selected. Further, finishing such as “shift”, “rotate”, “punch hole” or “z-fold” is designated by using a check box 763. Further, when a discharge destination is forcibly fixed, a “forcibly fix discharge destination” check box 764 is selected. Further, when “staple” is selected in the “discharging” pull-down list box 762, a “designate staple position” button 765 is depressed, thereby a staple position is designated.

By depression of a “details of finishing” button 766, further detailed finishing can be set. Further, by depression of a “restore normal setup” button 767, these settings can be set to default settings. When the operator has completed the setting in the printer driver property setup screen, an “OK” button 768 is depressed, thereby these print attributes are reflected in actual printing. When the settings in the property setup screen are to be cancelled, a “cancel” button 769 is depressed. Further, a “help” button 770 displays a help screen for explanation of the property setup screen.

[Flow when Print Mode and Service Mode are Mixed]

Next, an example of job control in the service mode will be described. The MFP 100 operates as a job processing device which can handle a job obtained by reading an original by the MFP itself or a job inputted from an external device such as the client PC 102 or the client PC 102, in the normal mode (job processing mode) or the service mode.

When the operator performs maintenance on the device (MFP 100), an operation screen of the device is changed from the normal mode to the service mode, and exchange and/or adjustment of respective modules inside the device is performed. In the service mode, for example, adjustment, cleaning, part exchange, maintenance, checking and the like in the MFP 100 are available.

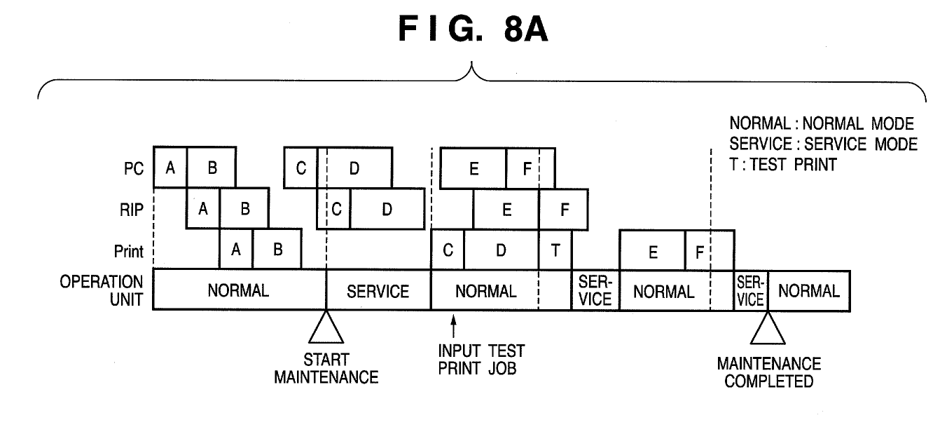

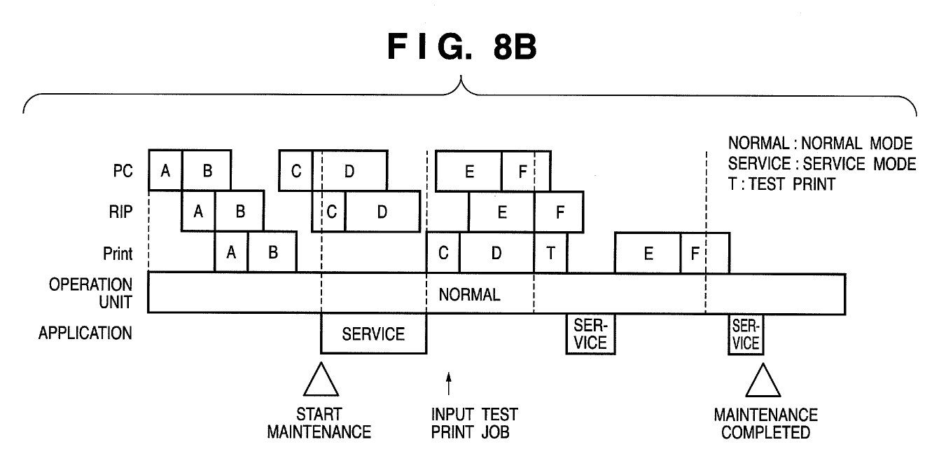

In FIG. 8A, “PC” indicates time of print instruction (job input time) from the client PC 102 (computer to input a job) in FIG. 1. Alphabets A to F designate other jobs. In FIG. 8A, six jobs are inputted. “RIP” indicates time in which a job inputted into the MFP 100 is processed by the RIP unit 204. Further, “Print” indicates time upon job print output by the printer unit 208. Further, “normal” and “service” in “operation unit” means “normal mode operation” and “service mode operation”. The normal mode operation means normal job waiting status by operation of the operation unit 210 as described in FIGS. 3A to 3C. The service mode operation means any operation or control status by utilizing the service mode or the like by the operator's operation of the operation unit 210, i.e., a status where the operator occupies the MFP 100.

The jobs A, B, C, D, E and F are inputted from the client PC 102 regardless of maintenance operation in the MFP 100. Assuming that the operator has started maintenance after the completion of the job B, the operator sets the MFP 100 into the service mode by operating the operation unit 210, and performs some adjustment operation. At this time, the print operation related to the normal jobs comes into a waiting status, and after the completion of the adjustment operation, the MFP 100 returns to the normal operation mode, thereby printing of the jobs C and D is performed.

In this arrangement, jobs can be received even in the service mode. However, the above flow has a big problem. For example, when the operator is to perform a one-sheet test print (T) to check adjustment reflected in actual printing, the test print job cannot be performed until the stored jobs C and D have been processed. For example, when test print is to be performed at the timing of “input test print” in FIG. 8A, the output of test print is waited until the printing of the jobs C and D have been completed. In this case, it is impossible to immediately determine whether an adjusted image is appropriate. In addition, in a POD environment, jobs usually are printing of large number of pages or large number of copies. In such case, the purpose of adjustment may be lost.

[Flow when Normal Mode and Remote Service Mode are Mixed]

An application program which enables a similar operation to that of the operation unit 210 from the client PC 102 via the network without the operation unit 210 has appeared. FIG. 8B is a timing chart showing job processing in the normal mode and the service mode (remote service mote) when such application program is used. The items PC, RIP and Print are the same as those in FIG. 8A. In FIG. 8B, it is seemingly always possible to input a job from the operation unit 210 of the MFP 100. Actually, the application software on the client PC 102 (in FIG. 8B, “application”) issues a service maintenance instruction to the MFP 100 as in the case of the service mode in FIG. 8A.

In this case, upon test print, a similar problem to that in FIG. 8A occurs, and in such case, it is difficult to check whether or not service maintenance has been appropriately performed.

Regarding the above problem, generally, during maintenance work, operations and data transmission/reception are performed mainly regarding image forming apparatus, while upon job input, it takes much time in RIP and image processing. That is, in many cases, actual use of printer by job input may be performed later at once.

[Flow in Service Mode in Present Embodiment]

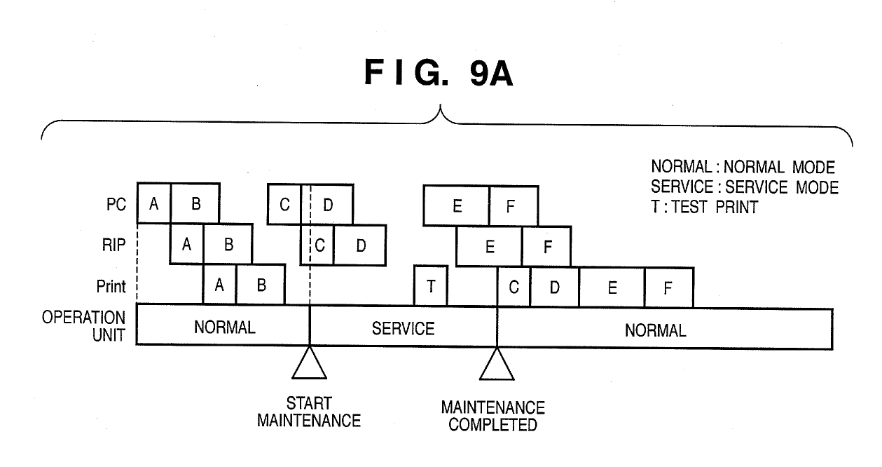

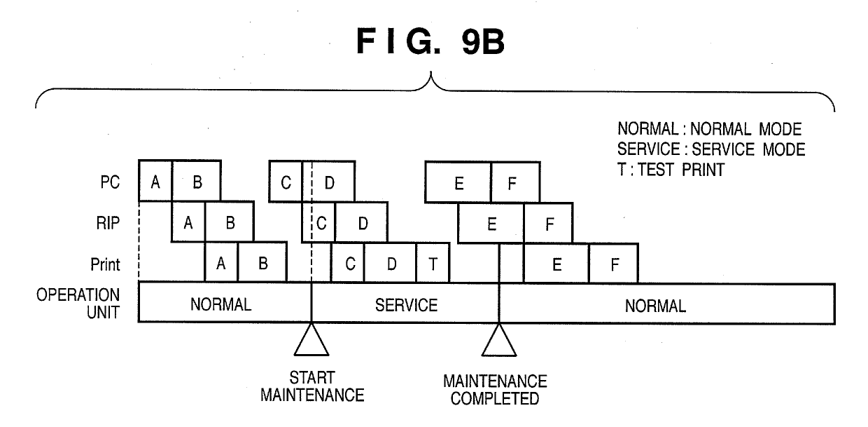

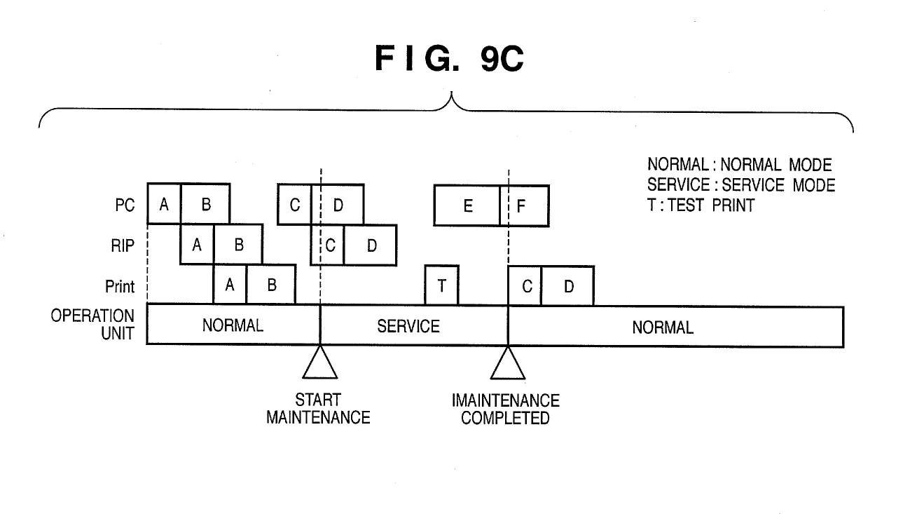

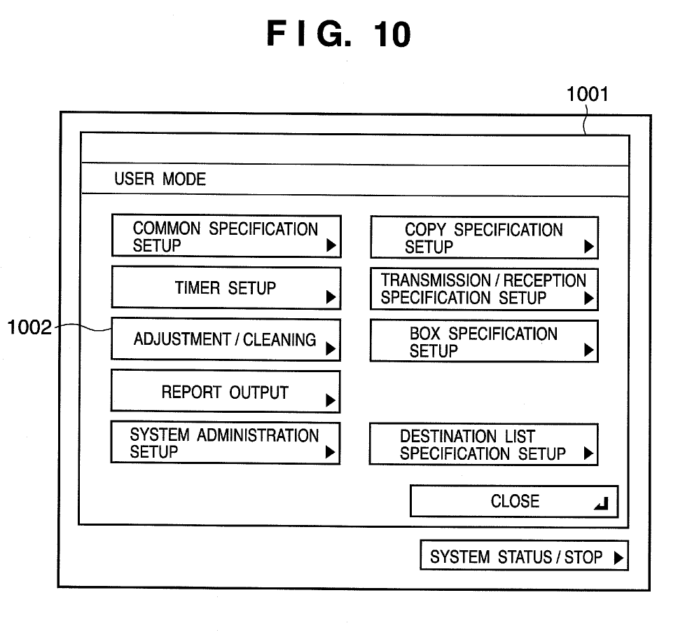

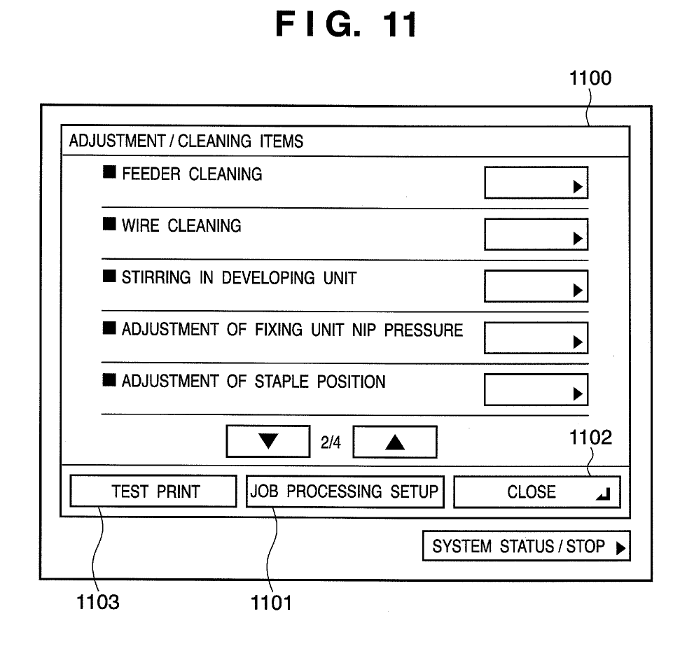

For example, as shown in FIG. 9A, a flag or the like switched between the normal print mode and the service mode is provided, and input of general print job is prevented during the service mode. Such flag is turned ON between the start and end of maintenance in FIG. 9A, and turned ON from depression of an adjustment/cleaning button 1002 in FIG. 10 to depression of a close button 1102 in FIG. 11. Hereinbelow, the flag will be referred to as a service mode flag. Note that as described above, change to the service mode and completion of the service mode and the like may be performed by using the MFP operation unit 210 or may be performed by a remote operation from the client PC 102 via the network 110.

A general job inputted during the service mode is subjected to RIP by the RIP unit 204 and stored in the memory unit 206. Generally, when a print job is processed, time for transferring PDL data from a client and time for RIP developing of PDL data take a large part of the entire print time. Accordingly, as shown in FIG. 9A, data transfer and RIP developing are first performed, then printing is performed at once after the completion of the service mode, thereby the MFP 100 can be efficiently used.

Then after the termination of the service mode, the service mode flag is reset, and the jobs stored in the memory unit 206 are sequentially released. In the present embodiment, “release” means enabling the stored jobs processable such that they are completed. The job release attains print output by the printer unit 208. Note that upon job release, the operator can establish the priority of the jobs stored in the memory 206.

By the above processing procedure, as shown in FIG. 9A, from the viewpoint of performance, the time for maintenance work and waiting times of the respective jobs are reduced. Thus, as a whole, efficient running is realized.

[Service Mode]

The mode change to the service mode is performed by, e.g., the following operation. First, when a user mode key 320 (FIG. 3B) on the operation unit 210 is depressed, a user mode menu screen 1001 as shown in FIG. 10 is displayed on the display screen of the touch panel unit 302. When the adjustment/cleaning button 1002 prepared in the user mode menu screen 1001 is depressed, the MFP 100 enters the service mode. By the transition to the service mode, an adjustment/cleaning item setup screen 1100 as shown in FIG. 11, for example, is displayed on the display screen of the touch panel unit 302. When the close button 1102 of the setup screen 1100 is depressed, the service mode is terminated.

The adjustment/cleaning items shown in FIG. 11 as an example are as follows.

“Feeder Cleaning”

When pencil powder or the like is attached to the paper feed roller 512 in FIG. 5B, about ten blank sheets are set in the feeder such that the particles are removed from the paper feed roller 512 to the sheets thereby attachment of the particles to print sheets is prevented.

“Wire Cleaning”

The charging wire of the primary charger 443 in FIG. 4C is cleaned by self reciprocal motion of molt plane or the like. This cleaning is performed when stripes appear on a print sheet in a subscanning direction.

“Stirring in Developing Unit”

When density unevenness occurs in a main scanning direction, to ensure uniform process conditions, developing material is stirred in the developing units 445Y, 445M, 445C and 445K in FIG. 4C.

“Adjustment of Fixing Unit Nip Pressure”

As shown in FIG. 4F, upon passing of printed sheet 491 through the fixing unit 404, if the pressure of engagement between the fixing roller 481 and the pressure roller 482 is too high, the outputted sheet is wrinkled. On the other hand, if the pressure is too low, toner attachment may be insufficient. The nip pressure is adjusted for adjustment of the above pressure.

“Adjustment of Staple Position”

To prevent stapling error by the stapler 604 in FIG. 6, a staple position by the stapler 604 is adjusted in mm units. Note that as stapler adjustment items, “adjustment of staple projection” (a white sheet is stapled and checked whether or not a staple is normally driven) and the like are used.

[Service Mode Processing Procedure in Present Embodiment]

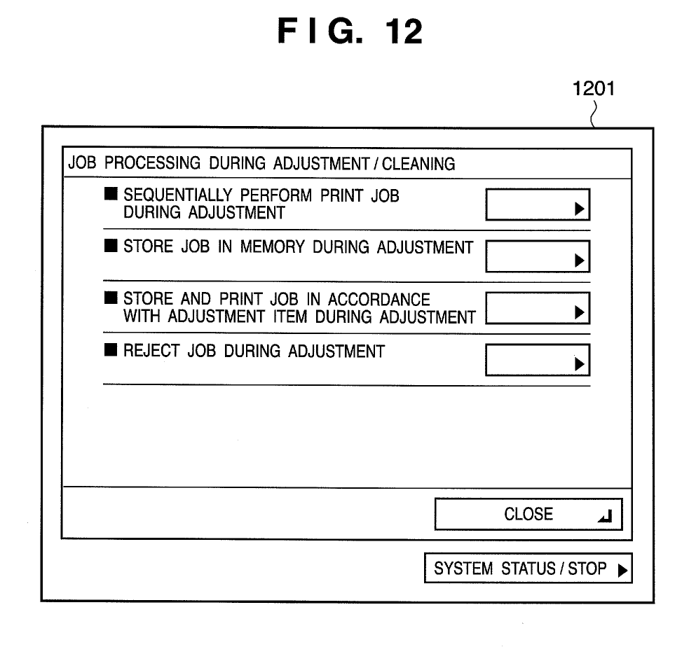

In the present embodiment, when a “job processing setup” button 1101 in FIG. 11 is depressed, a “job processing during adjustment/cleaning” screen 1201 as shown in FIG. 12 is displayed. In the setup screen 1201, job processing for a job inputted in the service mode is selected by the operator (job processing selection). In this example, the following four operations (job processing modes) are shown.

(a) Sequentially perform print job during adjustment

(b) Not output but store job in memory during adjustment

(c) Store and print job in accordance with adjustment item during adjustment

(d) Reject job during adjustment

In the job processing mode (a), as shown in FIG. 9B, regardless of during adjustment (service mode) or not, RIP-developed jobs are sequentially print-outputted. In the job processing mode (b), during adjustment (service mode), jobs are subjected to RIP developing then stored in the memory unit 206, and printing is waited (FIG. 9A).

In the job processing mode (c), processing method for each job is changed in correspondence with type of adjustment item set in the setup screen 1100 in FIG. 11. For example, in the case of “feeder cleaning”, as the cleaning does not influence the print operation, the job processing mode (a) is selected. On the other hand, in the case of “stirring in developing unit”, as the stirring operation influences the print operation (influences an image), the job processing mode (b) is selected.

Further, in the job processing mode (d), during adjustment, any job from the client is not accepted, but a warning message or the like is issued to the client side thereby inform the client side of print-disabled status (FIG. 9C).

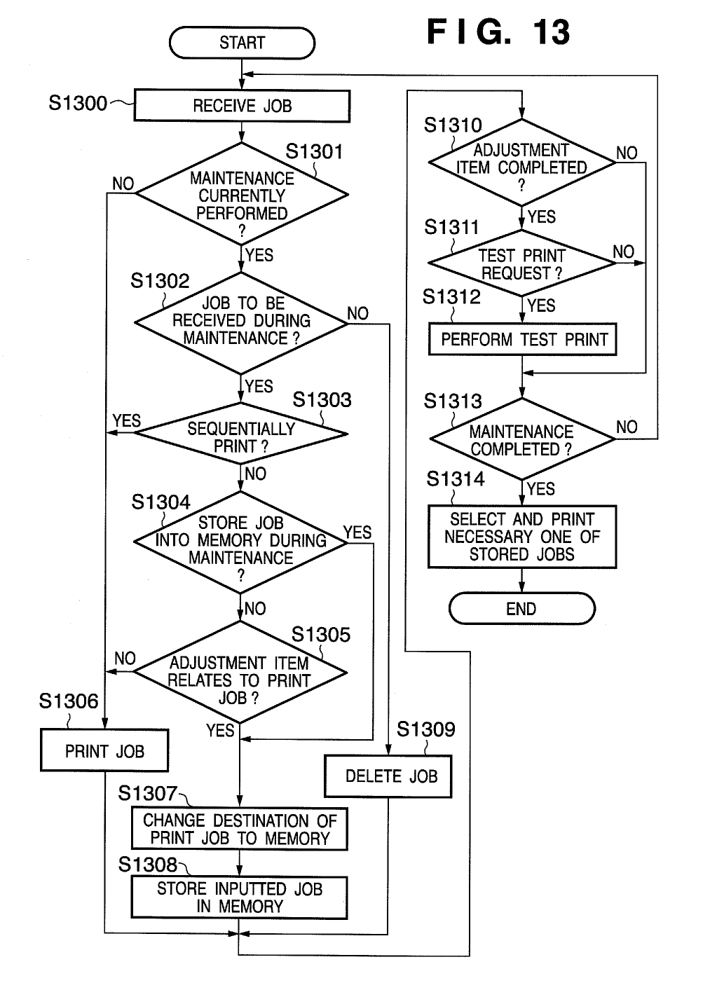

Next, the job processing procedures by the MFP 100 according to the present embodiment will be described with reference to the flowchart of FIG. 13.

When a job inputted from a client is received at step S1300, the MFP 100 determines whether or not maintenance work is being performed in the MFP 100 itself, i.e., whether or not the MFP 100 is in the service mode, at step S1301. The determination is made based on whether or not the above-described service mode flag is ON. When the MFP 100 is not in the service mode, the process proceeds from step S1301 to step S1306, at which the received job is sequentially RIP developed and print-outputted.

When maintenance work is performed in the MFP 100, the process proceeds to step S1302. At step S1302, it is determined whether or not the job processing mode (d) is set. When the job processing mode (d) is set, as any job received during maintenance is rejected, the process proceeds to step S1309, at which the job is deleted.

When the job processing mode (a) is set, as printing is sequentially performed, the process proceeds from step S1303 to step S1306, at which the received job is sequentially RIP-developed and print-outputted.

When the job processing mode (b) is set, to store the job received during the maintenance into the memory, the process proceeds from step S1304 to step S1307, at which the output destination of the received job is changed to the memory unit 206. Then at step S1308, the received job is RIP-developed and the result of processing is stored into the memory unit 206.

When the job processing mode (c) is set, the process proceeds from step S1304 to step S1305, at which it is determined whether or not a currently executed (selected) adjustment/cleaning item influences the print operation. If it is determined that the currently executed adjustment/cleaning item does not influence the print operation, the process proceeds from step S1305 to step S1306, at which the received job is RIP-developed and print-outputted. On the other hand, if it is determined that the currently executed adjustment/cleaning item influences the print operation, the process proceeds from step S1305 to step S1307. At step S1307, the output destination of the received job is changed to the memory unit 206. At step S1308, the received job is RIP-developed, and the result of processing is stored into the memory unit 206.

Thereafter, when the processing of the current adjustment/cleaning item has been completed, the process proceeds from step S1310 to step S1311, at which the MFP 100 can enter a test print executable status. In this status, for example, when a test print button 1103 in the screen of FIG. 11 is depressed, the process proceeds from step S1311 to step S1312, at which the MFP 100 enters the test print mode. In the test print mode, original reading and print output operation is executable by operation of the start key 313, and test print can be performed. Otherwise, it may be arranged such that test print is performed by print-outputting test print PDL data inputted from an external PC.

The above processings are repeated by the issuance of instruction of termination of maintenance (step S1313). When the termination of maintenance is instructed (in the present embodiment, the close button 1102 is depressed), the process proceeds to step S1314, at which printing is performed using the RIP-processed data stored in the memory unit 206 at step S1308.

In the above processings, when the job processing mode (a) is designated, as job(s) received in the service mode are sequentially print-outputted during the service mode, the operation as shown in FIG. 9B is performed. In this case, the test print instructed in the service mode is performed after the completion of the job C and the job D.

Further, when the job processing mode (b) is designated, the operation as shown in FIG. 9A is performed. That is, a job is accepted in the service mode, and the job is subject to the RIP developing processing. Then the job RIP-developed in the service mode is stored into the memory unit 206. Further, when the job processing mode (c) is designated, if an adjustment/cleaning item which influences printing is performed, the operation as shown in FIG. 9A is performed, while if an adjustment/cleaning item which does not influence printing is performed, the operation as shown in FIG. 9B is performed. Note that an adjustment/cleaning item which influences printing and an adjustment/cleaning item which does not influence printing may be selected during one maintenance period. In this case, only job(s) received when the execution of the adjustment/cleaning item which does not influence printing are sequentially print-outputted, while the other jobs are stored into the memory unit 206.

Further, when the job processing mode (d) is designated, as any job is rejected during the service mode, the operation as shown in FIG. 9C is performed. Note that a job received before the transition to the service mode and a job subjected to the RIP developing processing before the transition to the service mode are handled as in the case of the job processing mode (b). That is, after the processing by the RIP unit 204, the jobs are stored into the memory unit 206, and after the termination of the service mode, the jobs are print-outputted.

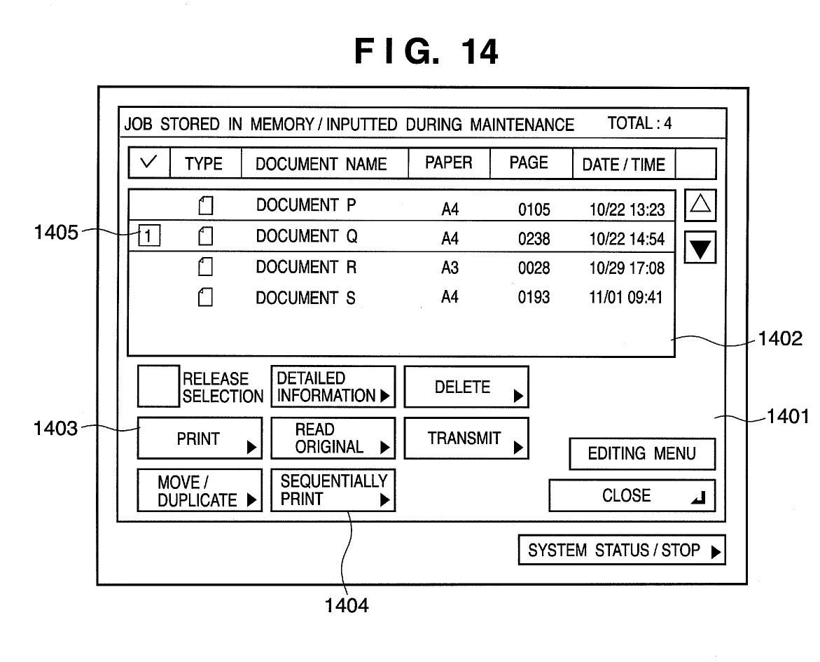

As described above, at steps S1302 to 1309, while the service mode flag is ON, jobs are processed in correspondence with the selected job processing mode (a) to (d). When the job processing mode (b) or (c) is selected and a job is stored into the memory unit 206 at step S1308, then after the completion of the maintenance, an operation screen 1401 as shown in FIG. 14 is displayed on the display screen of the touch panel 302 at step S1314. All the jobs stored in the memory unit 206 during the maintenance are displayed on a job list 1402 of the operation screen 1401. Note that when the job processing mode (d) is selected and a job is RIP-developed after the transition to the service mode and stored into the memory unit 206, the same operation is performed. The operator selects a necessary job from the job list 1402 on the operation screen 1401 and depresses a print button 1403, thereby performs print-output of the desired job. Further, when plural jobs are selected from the job list 1402, the priority is established in accordance with the order of selection, then when the print button 1403 is depressed, the jobs are print-outputted in the priority order (selected order). At this time, the operability is improved by the explicit job priority expression. In the present embodiment, the priority order is explicitly indicated on the left side of each job as indicated with reference numeral 1405. Note that when a sequential print button 1404 is depressed, the print jobs on the job list 1402 are sequentially print-outputted in the order of input time.

[Processing When Power OFF/ON is Required During Maintenance]

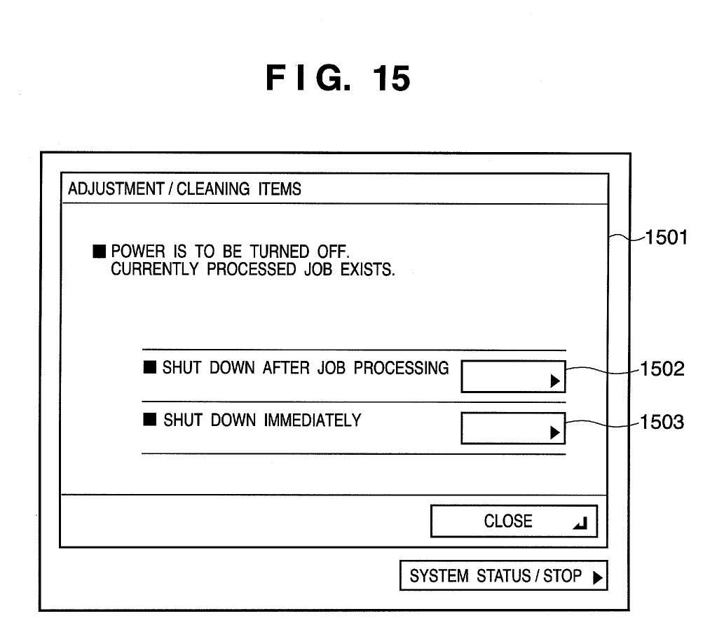

It may be necessary to turn the power OFF/ON in accordance with maintenance situation. For example, when device adjustment and cleaning operations are performed in accordance with the adjustment items shown in FIG. 11 then the power OFF/ON is required, the MFP 100 displays a shut-down operation screen 1501 as shown in FIG. 15 on the touch panel unit 302. When the power OFF/ON is required in the service mode in the timing charts of FIGS. 9A to 9C, it can be assumed that the job D is being RIP-processed. Accordingly, from the operation screen 1501 shown in FIG. 15, the user selects processing for the currently-processed job (job D in this example).

In FIG. 15, when a “shut down after job processing” button 1502 is depressed, the subsequent jobs are not accepted, and when the currently processed job (job D) has been processed, the power of the MFP 100 is turned OFF. Further, when a “shut down immediately” button 1503 is selected, a shut down sequence is immediately started even though the currently processed job exists. When a job currently RIP-processed exists, data prior to the RIP (PDL) is left but post-RIP data being generated is deleted, and the shut town sequence is started. Then, when the power is turned ON again, the job RIP processing is restarted.

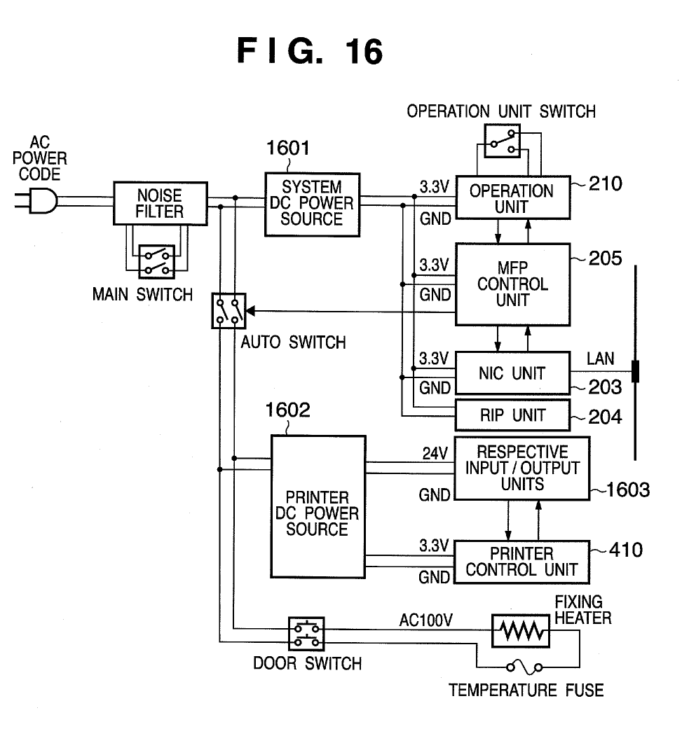

Otherwise, as shown in FIG. 16, it may be arranged such that RIP processing or the like can be continued even occurrence of power ON/OFF of printer DC power system in accordance with service mode (maintenance) by dividing the system into a system DC power system and a printer DC power system.

Note that the system DC power system including the MFP control unit 205, the operation unit 210, the NIC unit 203, the RIP unit 204 and the like operates with power supply from a system DC power source 1601. The printer DC power system including respective input/output units 1603 represented by mechanical-electronic control, the printer control unit 410 and the like operates with power supply from a printer DC power source 1602. Generally, as the power OFF/ON requirement frequently occurs in accordance with printer side adjustment item, the requirement is usually met by turning OFF/ON the power source of the printer control unit 410 or the like. Accordingly, only the printer DC power source system (printer DC power source 1602) is turned OFF/ON, and the job reception, RIP processing and the like can be always performed with the system power source system including the NIC unit 203, the RIP unit 204, the MFP control unit 205 and the like.

Note that the operation screens shown in FIGS. 10, 11, 12, 14 and 15 are provided by the operation unit 210 of the MFP 100, but the invention is not limited to this arrangement. For example, the client PC 103 in which the service maintenance application software is installed may provide a GUI as shown in FIGS. 10-12, 14 and 15 for remote adjustment/cleaning settings.

As described above, according to the above embodiment, even a general print job is inputted during maintenance work, efficient job processing can be realized. When such general print job is input during maintenance work, if printing based on the print job is performed, image quality degradation or the like occurs, and total efficiency is reduced. Accordingly, the job is temporarily saved in a buffer memory or the like in the image forming apparatus. That is, the input of all the jobs during the maintenance work is not prohibited but the job reception is enabled. The job is subjected to RIP or image processing which requires much time, then held as a print-ready file in the memory. Thus the efficient running of the entire print system can be realized. That is, as shown in FIG. 9A, the service mode is ensured while a job is accepted, thereby more efficient running can be realized.

Further, according to the above embodiment, as a job can be accepted during device maintenance, the work can be efficiently performed, and further, even upon occurrence of failure or the like, the job can be executed as scheduled. Further, considering the time until a job F has been print-outputted, the chance of improvement in total performance can be increased.

Note that in the above embodiment, the processing on a job to be print-outputted in the MFP 100 has been described, but the processing is applicable to a FAX transmission/reception job, a box print job and the like. For example, in the case of a job regarding FAX reception, a job, FAX-received in the service mode when the job processing mode (b) is designated, is stored as a print-ready file into the memory unit 206.

### Other Embodiment

In addition to the above-described embodiment, the present invention can be implemented as a system, an apparatus, a method, a program or a storage medium and the like. More particularly, the present invention can be applied to a system constituted by a plurality of devices, or to an apparatus comprising a single device.

Further, the object of the present invention can also be achieved by providing a software program for performing the functions of the above-described embodiment directly or remotely to a system or an apparatus, reading the program code with a computer of the system or apparatus, then executing the program. In this case, the program corresponds to the flowchart shown in the figures and described in the above embodiment.

Accordingly, the program code installed in the computer to realize the functions according to the embodiment realizes the invention. That is, the present invention includes the computer program to realize the functional processing of the present invention.

In this case, as long as the system or apparatus has the functions of the program, the program may be executed in any form, such as object code, a program executed by an interpreter, or script data supplied to an operating system.

Example of storage media that can be used for supplying the program are a floppy® disk, a hard disk, an optical disk, a magneto-optical disk, a CD-ROM, a CD-R, a CD-RW, a magnetic tape, a non-volatile type memory card, a ROM, and a DVD (a DVD-ROM and a DVD-R).

As for the method of supplying the program, a client computer can be connected to a website on the Internet using a browser of the client computer, and the computer program of the present invention (or an automatically-installable compressed file of the program) can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiment can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing in accordance with the designations of the program so that the functions of the foregoing embodiment can be implemented by this processing.

According to the present invention, even during a service mode (for example, during maintenance work), a general job can be received, and the received job can be efficiently processed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-023623, filed on Jan. 31, 2006, which is hereby incorporated by reference herein in its entirety.

What is claimed is:

1. A job processing method in a job processing apparatus operative in a normal mode to execute normal job processing and in a service mode, comprising:
a job processing selection step of previously selecting job processing for a job inputted in said service mode; and
a job processing execution step of processing a job inputted in said service mode in accordance with the processing selected at said job processing selection step.

2. A job processing method in a job processing apparatus connectable to an external device via a network, comprising:
a control step of executing an operation mode selected from plural operation modes including a normal mode to process a job inputted from said external device or said job processing apparatus and a service mode to perform previously set service in accordance with an instruction from said external device or said job processing apparatus;
a job processing selection step of previously selecting job processing for a job inputted in said service mode; and
a job processing execution step of applying processing according to the job processing selected at said job processing selection step to a job inputted from said external device or said job processing apparatus in said service mode.

3. The method according to claim 1, wherein said service mode is an operation mode to execute processing with a purpose of at least one of adjustment, cleaning, part exchange, maintenance and checking of said job processing apparatus.

4. The method according to claim 1, wherein said normal mode is an operation mode including processing to print-output inputted print data or image data obtained by optically reading an image.

5. The method according to claim 1, further comprising a step of executing test print in said service mode.

6. The method according to claim 1, wherein selectable job processing at said job processing selection step includes storage processing to perform developing processing on a job received in said service mode and store the processed job into a memory, and after the termination of said service mode, print-output the job developed into an image, from said memory.

7. The method according to claim 6, wherein in said storage processing, after the termination of said service mode, a job to be print-outputted is selected by a user from stored jobs, and the selected job is print-outputted.

8. The method according to claim 1, wherein, when power OFF of said job processing apparatus is required in said service mode, whether the power is to be immediately turned OFF or turned OFF after the completion of the processing selected at said job processing selection step for the received job can be selected.

9. An image forming apparatus having a normal mode to execute normal job processing and a service mode, comprising:
a job processing selection unit adapted to previously select job processing for a job inputted in said service mode; and
a job processing execution unit adapted to process a job inputted in said service mode in accordance with the processing selected by said job processing selection unit.

10. A job processing apparatus connectable to an external device via a network, comprising:
a control unit adapted to execute an operation mode selected from plural operation modes including a normal mode to process a job inputted from said external device or said job processing apparatus and a service mode to perform previously set service in accordance with an instruction from said external device or said job processing apparatus;
a job processing selection unit adapted to previously select job processing for a job inputted in said service mode; and
a job processing execution unit adapted to apply processing according to the job processing selected by said job processing selection unit to a job inputted from said external device or said job processing apparatus in said service mode.

11. The apparatus according to claim 9, wherein said service mode is an operation mode to execute processing with a purpose of at least one of adjustment, cleaning, part exchange, maintenance and checking of said job processing apparatus.

12. The apparatus according to claim 9, wherein said normal mode is an operation mode including processing to print-output inputted print data or image data obtained by optically reading an image.

13. The apparatus according to claim 9, further comprising a unit adapted to execute test print in said service mode.

14. The apparatus according to claim 9, wherein selectable job processing by said job processing selection unit includes storage processing to perform developing processing on a job received during said service mode and store the processed job into a memory, and after the termination of said service mode, print-output the job developed into an image, from said memory.

15. The apparatus according to claim 14, wherein in said storage processing, after the termination of said service mode, a job to be print-outputted is selected by a user from stored jobs, and the selected job is print-outputted.

16. The apparatus according to claim 9, wherein, when power OFF of said job processing apparatus is required in said service mode, whether the power is to be immediately turned OFF or turned OFF after the completion of the processing selected by said job processing selection unit for the received job can be selected.

17. A control program stored in a computer-readable medium for executing the job control method in claim 1 by a computer.

18. A computer-readable memory holding a control program for executing the job control method in claim 1 by a computer.
